(19) United States
(12) Patent Application Publication
(10) Pub. No.: US 2010/0049556 A1
(43) Pub. Date: Feb. 25, 2010

(54) INTERNET MEDIATED BOOKING AND DISTRIBUTION SYSTEM

(75) Inventors: Andrew Liu, New South Wales (AU); Gary Gelenter, New South Wales (AU)

Correspondence Address: FULWIDER PATTON LLP, HOWARD HUGHES CENTER, 6060 CENTER DRIVE, TENTH FLOOR, LOS ANGELES, CA, 90045, US

(73) Assignee: TRAVEL WHO PTY LIMITED, Sydney, New South Wales (AU)

(21) Appl. No.: 12/516,795

(22) PCT Filed: Mar. 14, 2008
(86) PCT No.: PCT/AU08/00356

§ 371 Date: May 28, 2009

(30) Foreign Application Priority Data
Mar. 16, 2007 (AU) 2007901349

(51) Int. Cl. G06Q 50/00; G06Q 30/00; G06F 17/30

(52) U.S. Cl. 705/5; 705/26; 707/728; 707/655; 707/770; 707/E17.109; 707/E17.005

(57) ABSTRACT

The invention relates to a system for providing and pricing travel product inventory contained in external databases not under the control of the operator and additionally comprises ghost databases which are a mirror of the external databases. The system further comprises an information manager adapted to receive search criteria from a user and to apply pricing rules to the search results which determine the final display price quoted to the user. The information manager thereafter filters the priced search results by a productmaster UID to group the same actual travel product inventory as supplied by different suppliers, into a single search result, and then provides the grouped results to the user connected to the system via the communications module.

### TECHNICAL FIELD

This invention relates to internet mediated distribution systems, and more particularly, to an internet mediated booking and distribution system for the travel sector.

### BACKGROUND ART

The Internet mediated travel sales sector is a substantial market which has grown in size dramatically during the past few years and is well served by Web-based travel agencies and portals. Despite the proliferation of internet travel sites, no real attempt has been made to re-engineer the travel procurement and management process using the connectivity and low cost processing capability enabled by the Internet especially for smaller to mid sized players. Consequently, suppliers to the wholesale and retail sectors still face continuing high costs reflecting the inefficiencies of the industry which are further exacerbated by their own labour intensive processes.

Fundamental to this failure to re-engineer the procurement and management process has been the inability of the travel software industry to develop or produce a flexible, sophisticated product database allowing universal application for all travel products be it air, accommodation, car hire, rail passes, theatre tickets, sightseeing or coachtours.

Although individual product groups have been accommodated within a single database for some time, with the exception of the Global Distribution Systems (GDS) or Central Reservations System (CRS) such as Galileo, Amadeus or Sabre, Wholesale and Tour Operator software has been unable to adequately address this requirement, in particular, the inventory in these systems is incomplete and requires manual manipulation to incorporate into a booking.

Traditionally travel inventory has been distributed from supplier to consumer by way of a complex chain of operatives and intermediaries. FIG. 1 illustrates the parties involved and the following gives a brief description of their respective roles:
Suppliers 101: Are the providers (and often the owners) of the end service or product that is the hotel where you stay, the airline, the coach company that provided the transfer or the bungy jumping company that provides thrill seeking activities. These are all Suppliers and historically they have distributed their products and services via the travel intermediaries in the travel distribution chain.
Aggregators 102: Came into existence as the travel industry sought specialists in a particular field notably hotel contracting, day tour and sightseeing arrangements, theatre and restaurant bookings to name a few. Aggregators tend to stick to one specific field, for example, hotels and often to a specific region of the world, for example, Europe. They will then individually contract a selection of hotel properties within their chosen region at a discounted rate, which in turn they will on sell further down the supply chain with appropriate markups added. Historically aggregators have contracted inventory from the Suppliers and on sold it to wholesalers as the logical next distribution point along the distribution chain. However in recent years aggregators have courted the idea of distributing further down the chain both direct to agents and potentially affiliates where there are potentially greater earnings to be had than by distributing exclusively to wholesalers.
Global Aggregators 103: a global aggregator is a multinational entity that acquires the most popular, high volume and profitable inventories of local aggregators from around the world.
Wholesalers 104: Are the ‘packaging specialists’ in the distribution chain, bringing together disparate product in a single purchasable item. A good example of a wholesale package would be a trip consisting of flights, accommodation, transfers from and to the airport, day tours and sightseeing arrangements as well as supplementary items such as travel insurance. All these components would be ‘packaged’ together by the wholesaler, marked up accordingly and opaquely priced and on sold historically to the travel agent who would in turn sell to the affiliate or consumer. Wholesalers do buy direct from suppliers for their primary product, and in the past they have tended to purchase from aggregators who have spent time investigating, checking and contracting the products and services that they package into their secondary product line or “tours”. Most wholesalers will limit their business to a specific geographic region or type of package, such as adventure packages, ski packages and cruise packages, with the specific intention of becoming the best known brand for that type of package.
Travel Agents 105: Traditionally the travel agent has served as the first point of reference for a consumer wishing to plan his or her holiday. Some travel agents try to specialise in a specific type or region of travel much as the wholesalers do, whilst others are happy to sell general travel without any specialisation. The value of the travel agent in the distribution chain has historically been their ability to know what products and services are available for what destinations and to “translate” the jargon of travel for the everyday travel consumer. However, with the growth of the internet and the availability of clearly presented travel information much of the ‘mystique’ of the industry has been exposed.
Affiliates: Affiliates are organisations or bodies representing large groups of consumers that leverage their memberships to buy travel at favourable rates for their members. Positioned between the agent and the consumer within the distribution chain affiliates have tended to interact with the agency network though there is some movement towards direct relationships with both wholesalers and indeed suppliers. Good examples of affiliates would be credit card companies, common interest groups, sporting clubs etc.
Consumers 106: Are the end users, the actual travellers.

Although the above distribution chain is not a definitive description of the way the travel industry operates, it is a simplified depiction of the complex dynamics which make up the industry. For example, some travel industry operatives don't necessarily fall into one specific category that is wholesaler or aggregator but in fact represent a hybrid of the two. In any case, what is important to note is that there are many levels of intermediaries that sit between the suppliers and consumers in the travel industry.

Throughout the distribution chain there are complex remuneration calculations based on commissions and fees payable, override commissions and even “super override commissions” all of which influence the final sale price dependent upon the route of purchase the consumer follows. Significantly in extreme cases the supplier may only receive 20% of the final sale price, with up to 80% being “consumed” by the various distribution intermediaries.

Until now there has been no efficient process for selectively allowing different selling prices and/or paying variable commissions dependent upon the size, origin or source of a booking.

Although there have been a plethora of products developed addressing aspects of the travel distribution process, they have predominantly focused on booking capabilities, product/inventory management and reporting functionality without fully addressing the more complex pricing variables and inventory presentation addressed by this invention.

Systems developed for the Tour Operator sector and available prior to lodgement of the provisional application included products like Calypso, developed by the Tourism Technology group, Tourplan, Travel Manager as well as ResManager, Gilboa and Ezrez to name but a few. However none of the developers of Wholesale and Tour Operator software have addressed the issue of providing an automated pricing module which would apply variable pricing dependent upon the channel through which the purchase was made, the source from which the product was purchased and a selection of other criteria which could be applied to determine a sale price. The GDS/CRS providers are unable to offer this functionality

Travel agencies are traditionally rewarded for their service by way of commission payments and the commission amounts have typically varied from agency to agency dependent upon the level of support given by the agency. In more recent times, suppliers have moved to a position of selling to agents at a net price and allowing agencies to determine their own selling price by adding a service or booking fee. We are of the opinion that price remains largely the determinant factor in any travel purchase. Regardless of the buy price at which an agent purchases the product it is predominantly the same from agent to agent. The sell price can vary dramatically when agents willingly lower their sale price by ploughing back (discounting) their commission earned on a booking in the form of a consumer discount simply to gain volume and presumably a potential rebate.

Due to the shortcomings of the systems currently in use, which require a one to one calculation of price (one product equals one selling price) the need to differentiate on gross pricing is not available. Due almost entirely to this lack of functionality, the industry has responded by using variable commission levels and rebates to individual agencies (after sale kick backs). That is, as the suppliers of product such as hotel accommodation sell at the same price to each agency, the only way they can make adjustments to the final purchase price sold by the agent is through rebates and commissions applied manually after the sale process and outside of the system. An agency that services a supplier in some way more or additional to another agency will usually receive a greater upfront commission or rebate on the sale than another agent but the nominal buying price will be the same as for any other agent. Thus invariably reward for the more productive agent is by way of manually applied incentive payments which are claimed retrospectively by the participant agent on sales generated through the organisation.

The reality of existing systems development to date is that it is difficult, if not impossible, due to the resource levels required and the architecture of the current systems, to offer a different channel buy price. To date the wholesale industry response has naturally been to defend the use of variable commission and deferred payments and rebates, as they have no real alternative to offer.

Not only is there variability in the commissions and rebates paid to travel agents, and other intermediaries within the travel distribution chain but there can be, in some limited cases (where particular systems and applications allow for it) variability in the selling price for a product, depending on how the booking was made and where the product was sourced. For instance, some low cost carriers (LCC's) sell their tickets for a lower price i.e. cheaper online than had the booking been made through a telephone operator employed by the airline. Likewise the price of accommodation purchased online where that accommodation is dynamically priced dependent on a selection of criteria to reflect ‘real time’ market conditions in respect of availability, occupancy levels etc would not generally be offered to a customer either purchasing directly from the hotel reservations department or as a “walk-in” purchase (i.e. a client arriving at the hotel without a reservation).

Despite the availability of some systems that can handle variability in a product's price, in almost all instances regardless of how the booking was transacted, the selling price for each channel is identical. This is due in a large part to the lack of functionality in the underlying systems used by the majority of participants in the travel industry, particularly when interoperability is required. Flat pricing for product is the normal manner of selling product due to the current wide scale adoption of the single product pricing system with variable rebates and commissions.

For example, it is self evident that a booking made by telephone through the wholesaler's call centre costs the wholesaler more to transact than a booking made via an e-mail or a request from the wholesalers website. An online booking conducted via a booking engine through the wholesaler's website in an automated fashion has almost no marginal cost attached to it.

As stated earlier the systems used currently by participants in the travel industry do not generally allow for variability in a products selling price. Regardless of the sales channel, the wholesaler is under no incentive to seriously improve its productivity through the internet channel. It is not generally possible to charge a travel agent a lower gross price for product acquired via the internet than if it had been booked through a telephone operator. This presumably penalises both the wholesaler and the agent. The consumer will of course search for the lowest price. This situation however is now no longer acceptable to most operatives within the travel distribution chain because of shrinking margins. Encroachment by those very operatives into each other's traditional areas of distribution has put further pressure on them to provide discriminatory pricing based upon selective criteria applicable not dependent upon their position within the traditional supply chain.

Other systems have to date attempted to overcome this problem by simply replicating a product pricing methodology for every channel. This entails the wholesaler providing multiple versions of essentially the same product, reflecting the different channels through which they are sold and therefore with commensurate price differential. This results in unnecessary data duplication multiplied ‘n’ times where n is the number of different channels through which the product is sold. It also results in an increased opportunity for consultant error when the incorrect ‘product type’ is selected.

Another problem associated with current travel booking and search engine technology is that it is restricted to polling individual databases for inventory. As previously mentioned, the lack of a universal database capable of accommodating multiple product types of inventory from disparate sources has been a key cause of the stagnation in development of an effective distribution platform embracing the web technologies now readily available to the travel industry.

With respect to other travel inventory, searches are generally confined to the one database. Hotels generally distribute their inventory to a range of aggregators (see Travel Supply Chain); who in turn on sell to wholesalers. The wholesalers will predominantly buy specific regional product from specific aggregators specialising in that region, but occasionally they may buy from multiple aggregators who coincidentally may be providing the same product. In this scenario, the existing systems are unable to poll multiple databases.

The industry has reacted to the issue of multiple suppliers of the same product by adopting what is termed “preferred supplier arrangements. These arrangements effectively reduce the complexity of the offering, and the search effort required by the staff involved, by reducing the choices available.

This means that often inventory that may be available from other sources, that is, other databases not polled, is not shown as available because the single source interrogated has returned “nil availability” for the specific inventory contained in the database polled.

Put simply, other sources are ignored by the current systems because of the complexity of implementing multiple source searches for the same type of non-air product. This inability to consolidate multiple non-air suppliers into a single search interface typifies the technology in the travel industry today.

The impact of this is felt throughout the travel distribution chain, with suppliers often holding unsold inventory, aggregators and wholesalers unable to meet client requirements because their allotments with the particular supplier have been filled and agents forced to approach alternate wholesalers or aggregators to buy the product or select alternate product as appropriate.

Another problem in the industry is that some travel booking systems historically have been unable to avoid publishing duplicate property information where the same property is offered by multiple suppliers.

In simple terms this has meant that when a hotel—say the Hilton Hotel in Melbourne—is offered for sale by multiple suppliers (wholesalers or aggregators), the traditional booking engine will list the Hilton Hotel Melbourne multiple times in its return of search data inventory and potentially could publish multiple prices for the same property reflecting the pricing of the different suppliers offering that product to the seller.

For wholesalers who have offline access to many aggregators and/or with direct deals with the supplier, the shortcomings of their current system will require them to select the “best” rate from a single alternative, and ignore all other sources, except in the most desperate of situations. These would include having confirmed a booking and then not actually having any inventory to deliver.

Additionally, consistency and standards in the industry in relation to naming conventions at least, are not high. As in the example above, the Hilton Hotel Melbourne can be known by many different titles including:
The Melbourne Hilton,
Melbourne Hilton
Hilton Melbourne
Hotel Hilton Melbourne

All of which are recognised identification of the same property. Furthermore, there is no industry standard for products other than air such as exists with the 2 and 3 digit coding model created for airlines and airports.

Obviously apart from being extremely confusing to the booking engine user, this practice is fraught with potential problems in terms of the correct property being selected and the price being paid etc.

A related problem is the publishing (or not) of whole supplier ranges of product so that a wholesaler will not show multiple occurrences of the same product. In the majority of cases the wholesaler will be forced to pick a single supplier for a city or region and then try and manually manage the problem of quoting a price based on the acquisition of product from one supplier while being forced to actually buy the product from another.

A further issue that has frustrated wholesalers and aggregators in the past has been the lack of consistency in content and descriptions. The quality and range of photo images and descriptions of the property amongst and between multiple suppliers can be vast. Latterly the impetus has been to force this on the individual properties to maintain and update the descriptions and content published. Traditional brochure based wholesalers will have solved this problem by spending time and money on selecting “unique” graphics and text for their brochure, but they of course are unable to sell through an online channel due to the limitations of their current systems.

Current wholesale and online systems provide a single mechanism to apply to foreign exchange rates when converting the currency of acquisition to the calculation required in determining a selling price. This is an especially onerous task. Consider that selling prices may be determined up to 12 months in advance, or where selling prices are nominally fixed for 12 months as in a brochure. The supplier has to calculate a rate that effectively balances its financial risk against its marketing risk. If the rate is set too high, no product will be sold. Conversely, setting the rate too low may result in significant losses being incurred. The setting of exchange rates is now more complicated then ever due to the plethora of market available foreign currency buying alternatives such as futures, options, caps, collars and hedges. And all of these have a cost that must be built into the selling rate. Under the present single rate pricing regimes, when foreign exchange rates move against a seller, the wholesale market responds with “currency surcharges”.

The competitive forces of the internet have allowed other players to make the rate daily and change prices accordingly, usually resulting in their having a significant price benefit. Inevitably the fixed price seller is being forced to reduce its published price (and margin) to match putting more pressure on margins.

Both techniques suffer from a lack of rigorous allocation of the underlying issue i.e. the rate that I sell at today is a surrogate for the time that the product is to be settled with the supplier, which may be 12 months into the future.

There is no mechanism available in current systems to capture the affect of time on the price of a product or service. In this sense time is the equivalent of risk. Currently whether forward exchange cover is taken or not the price of the product is set so that the price the buyer pays (and this is regardless of an efficient channel pricing mechanism) is the same price whether the purchase is for consumption now or in the distant future. In other words, the seller has to use a surrogate rate that covers the low(er) risk inherent in a purchase to be settled say next week, against the higher risk (of substantial negative exchange rate movements) in a purchase to be settled in 9 months.

The market response is of course to cover the risk by locking in an exchange rate for future periods, and then using a “better” rate to lock in a foreign exchange profit. This unfortunately ignores the “cost” of obtaining forward cover, which can be up to 5% of the cover acquired. And in the foreign exchange markets at least, risk as measured by time and interest rate differentials is discreetly priced into the transaction. Explicitly, the cost of acquiring an option for settling in 12 months time is higher than the cost of buying on the spot in the foreign exchange market.

All the above discussion of foreign exchange also applies to wholesalers who wish to sell in a foreign currency. Even in the case where the wholesaler may obtain a natural hedge (buying and selling products in the same currency) current systems deny the operator the opportunity to use differential pricing rather than inverse calculations. In other words, if the exchange rate from one currency to another is inflated to cover an inherent exchange risk, the current systems use the inverse of this (inflated) exchange rate, resulting in a higher cost to the consumer. Differential pricing would allow the seller to reflect the lower level of risk.

Any reference herein to known prior art does not, unless the contrary indication appears, constitute an admission that such prior art is commonly known by those skilled in the art to which the invention relates, at the priority date of this application.

It is an object of the present invention to substantially overcome some of the stated deficiencies of the prior art.

### DISCLOSURE OF INVENTION

According to one aspect of the present invention there is provided a system for providing travel product, wherein the travel product inventory is contained in at least one external database, the system comprising:

a datastore containing at least
one ghost database comprising a mirror of the at least one external database containing travel product inventory wherein the ghost database is periodically updated, and
a master database containing at least a clone of the ghost database and wherein each entry of the master database has assigned to it a unique identifier;

a communications module, which is adapted to communicate with the at least one external database and to receive search criteria from a user connected to the system via a network;

an information manager adapted to receive the search criteria and query the at least one external database containing travel product inventory; and wherein the information manager queries the at least one external database by first querying the master database to identify relevant travel product inventory, and if identified in the master database, uses this information to look up the corresponding entry in the ghost database, and;
in the case where the ghost database is updated frequently such that it represents an accurate representation of the availability and prices of the travel product inventory contained therein, the information manager uses the information contained in the ghost database, or
in the case where the ghost database is updated infrequently, the information manager uses the information obtained from the ghost database to access the at least one external database via the communications module, so as to obtain current pricing and/or availability of the relevant travel product identified in the earlier searches of the master database and at least one ghost database, and

wherein the search results, including the availability and/or the price of the travel product inventory revealed by the searches are returned to the user by the information manager via communications module and network.

Preferably, the system further comprises:

a cache for storing past search results; and

wherein the information manager searches the master database and at least one external database utilising:
an XML gateway of the information manager, which is adapted to direct the search criteria submitted by the user connected to the system, to both:
   an XML master database API further adapted to query the cache to identify any previously provided search results which meet the search criteria of the user and further adapted to query the master database for travel product inventory that meets the search criteria of the user; and
   an XML supplier API further adapted to first query the master database for travel product inventory that meets the search criteria of the user, and if identified, to use this information to look up the corresponding entry in the ghost database and if relevant product inventory is identified, query the cache to identify whether the relevant product information is stored in the cache, and if not stored or if the content of the ghost database is not accurate, queries the external database via communications module to determine actual availability and/or price.

In a further preferred embodiment there is a plurality of external databases each of which is in association with a XML supplier API.

More preferably, the search criteria includes destination criteria such that when the user starts to type the destination the system provides automatic suggestions from a list maintained in a destinational cache.

It is preferred that each destination comprises at least two hierarchical destination levels, including:

Country, and

City.

In a preferred embodiment, the unique identifier associated with entries in the master database includes at least a unique productmaster UID, product UID, and subproduct UID, and wherein the search results obtained by the information manager are analysed by it for duplicate entries that have the same productmaster UID, and wherein the information manager then groups these duplicate entries together before providing the grouped search results to the user connected to the system.

More preferably, the unique identifier associated with entries in the master database includes at least a unique productmaster UID, product UID, and subproduct UID, and wherein search results returned by the XML master database API and XML supplier API of the information manager are analysed by the information manager for duplicate entries that have the same productmaster UID.

According to a second aspect of the present invention, there is provided a system for pricing travel product, the system comprising:
a datastore for containing at least one master database having at least a set of rules wherein the rules are applicable to the pricing of travel products;
an information manager for:
   receiving search criteria from a user connected to a system,
   identifying the user,
   querying at least the master database in the datastore,
   applying the rules applicable to any travel product inventory identified so as to obtain a display price,
   sending the search results to the user connected to the system, including the display price of the travel product identified in the search results,
   receiving orders for the purchase or reservation of the travel product; and
a communications module for communicating with at least the user connected to the system via a network.

Preferably, the system further comprises:
a cache for storing past search results which are accessed by the information manager in order to speed up database queries of at least the master database,
wherein the rules provide for at least:
   differential prices to be paid based on the user,
   differential prices to be paid based on sales channels, and
   differential prices to be paid based on the product.

It is preferred that the information manager of the system is further adapted to query at least one external database in addition to the master database of the system, and wherein
the datastore further comprises:
   at least one ghost database for the or each external database,
   the master database which further comprises a clone of the or each ghost database,
the information manager further comprising:
   an XML gateway, which is adapted to direct the search criteria submitted by the user connected to the system, to both:
      an XML master database API further adapted to query the cache to identify any previously provided search results which meet the search criteria of the user and further adapted to query the master database for travel product inventory that meets the search criteria of the user;
      an XML supplier API further adapted to first query the master database for travel product inventory that meets the search criteria of the user, and if identified, to use this information to look up the corresponding entry in the ghost database and if relevant product inventory is identified, query the cache to identify whether the relevant product information is stored in the cache, and if not stored or if the content of the ghost database is not accurate, queries the external database via communications module to determine actual availability and/or price; and
wherein the results of the queries of both XML master database API and XML supplier API then have the rules applied to them in order to obtain the display price and are thereafter provided to the user via the communications module and network.

In a preferred embodiment, there is an assigned hierarchy to the rules so that certain rules take precedence over others, and wherein the rules can be applied either:
cumulatively, or
absolutely, or
a combination of absolutely and cumulatively; and

wherein the rules define at least the markup, discount, and commission payable in respect of a particular travel product inventory.

Preferably, the system of claim 7 wherein before the information manager applies the rules applicable to the travel product inventory identified, the information manager first applies a currency conversion and wherein the rate of conversion is derived from a combination of the applicable spot rate, currency hedge and forward margin.

In a third aspect of the present invention there is provided a system adapted to eliminate duplication in the results of the search conducted for travel product inventory in a system which contains multiple instances of actual travel product inventory supplied by different suppliers, the system comprising:
a datastore for storing a master database containing travel product inventory wherein each entry in the master database has a unique selectionID including unique productmaster UID, product UID, and subproduct UID;
an information manager adapted to:
   receive search criteria from a user connected to the system,
   query at least the master database of the datastore for relevant travel product inventory, and
   analyse the returned search results for instances where the entries of the master database returned have identical productmaster UIDs, and groups these entries with identical productmaster UIDs together, and provides the results to the user grouped by productmaster; and
a communications module for communicating with at least the user over a network.

According to a fourth aspect of the present invention, there is provided a system for providing and pricing travel product inventory contained in at least one external database, comprising:
a datastore containing:
   at least one ghost database where the or each ghost database represents a mirror of the at least one ghost database having travel product inventory contained therein;
   a master database containing a clone of the at least one ghost database wherein each entry of the master database has assigned to it a unique selection ID comprising unique productmaster UID, product UID, and subproduct UID;
an information manager adapted to:
   receive search criteria from a user connected to the system,
   identifying the user,
   querying the master database from the datastore,
   querying the at least one external database containing travel product inventory,
   applying the pricing rules applicable to any travel product inventory identified through querying the databases,
   analysing the search results for instances of entries in the search results that contain the same unique productmaster UIDs,
   grouping the entries with the same unique productmaster UIDs,
   returning the search results that have been priced and grouped according to productmaster UID to the user connected to the system, via
a communications module which is adapted to communicate with the at least one external database and the user via a network.

Preferably, the system further comprises:
a cache for storing past search results; and
wherein the information manager further comprises:
   an XML gateway, which is adapted to direct the search criteria submitted by the user connected to the system, to both:
      an XML master database API further adapted to query the cache to identify any previously provided search results which meet the search criteria of the user and further adapted to query the master database for travel product inventory that meets the search criteria of the user;
      an XML supplier API further adapted to first query the master database for travel product inventory that meets the search criteria of the user, and if identified, to use this information to look up the corresponding entry in the ghost database and if relevant product inventory is identified, query the cache to identify whether the relevant product information is stored in the cache, and if not stored or if the content of the ghost database is not accurate, queries the external database via communications module to determine actual availability and/or price; and

wherein the results of the queries of both XML master database API and XML supplier API are returned to the user connected to the system via communications module and network.

It is preferred that the rules provide for:
differential prices to be paid based on the user;
differential prices to be paid based on sales channels; and
differential prices to be paid based on the product.

In a preferred embodiment the search criteria includes destination criteria such that when the user starts to type the destination the system provides automatic suggestions from a list maintained in the destinational cache and wherein each destination comprises at least two hierarchical destination levels, including:
Country, and
City.

Preferably, before the information manager applies the rules applicable to the travel product inventory identified, first applies a currency conversion and wherein the rate of conversion is derived from a combination of the applicable spot rate, currency hedge and forward margin.

In a fifth aspect of the present invention, there is provided a method for providing travel product through an integrated internet mediated travel booking system for use by travel agents, retail consumers, wholesalers and aggregators comprising the following steps:
defining rules applicable to the sale of travel products where rules provide for, at least,
   differential prices to be paid based on the user,
   differential prices to be paid based on sales channels, and
   differential prices to be paid based on the product; and
connecting to at least one database containing product information;
associating rules with the product information;
obtaining from a user a set of search criteria;
searching the at least one database for relevant product information, by applying the search criteria to its contents;
obtaining a first set of raw search results of relevant product information;
applying the set of rules which are applicable to:
   the user,
   the source database,
   the product;
   in order to derive a final sales price for the particular user;
analysing the search results for multiple instances of actual travel product inventory where a supplier has provided multiple subproducts and in those cases, grouping them together under the one product for each supplier;
grouping the grouped search results further, where the results relating to the same actual product offered by multiple suppliers are grouped and returned as one search result;
providing the grouped search results to the user with the calculated prices, grouped by actual product, via a communications module;
allowing the user to select the product and choose the supplier if multiple suppliers are available for an actual product, and thereafter;
completing the purchase and/or make a reservation.

Preferably, searching the at least one database comprises the following steps:
an XML gateway receiving from the communications module the search criteria provided by the user of the system;
the XML gateway performing a lookup of data contained in the datastore indicating where product of the desired service type requested might reside;
the XML gateway sending the search criteria to XML API's for accessing content contained in the master database, and any other external database which potentially contains product information of interest;
the master database XML API, an XML API having been provided the search criteria by the XML gateway, first querying the cache to determine whether there are any recent search results that meet the criteria of the user, and if no cached search results are identified, querying the master database for relevant product information, and at the same time, any supplier XML API sent the search criteria by the XML gateway then queries the master database for relevant product information specific to the external database and thereafter queries the ghost database contained within the datastore of the system, and in the event that relevant product information is identified, then queries the cache for any recently cached search result that contains the relevant product information and in the event that there is no relevant cached search results, will query the external database for up to date information including availability and/or price;
the master database XML API and any supplier XML API that has conducted a search then returning the search results for application of the rules so as to obtain a final price for any product information identified, based on the identity or type of user, and the source or channel of the product to which the product information relates;
providing the user with the search results as modified by the application of the rules via a communication module.

### BRIEF DESCRIPTION OF THE DRAWINGS

FIG. 1 is a flow chart showing the Traditional Travel Distribution Chain,

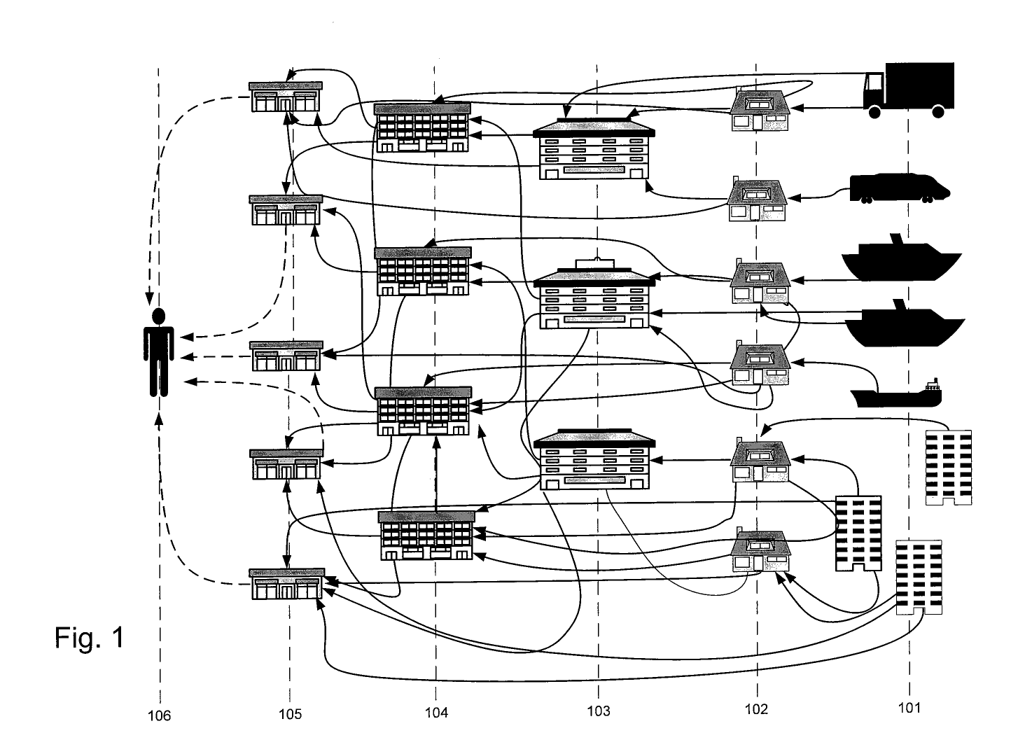

FIG. 2 is a schematic showing the components of the present invention,

FIG. 3 is a flow chart showing an example of a “product” relationship used in traditional systems,

FIG. 4 is a flow chart showing an example of a “productmaster” relationship used in the present invention,

FIG. 5 is a flow chart showing duplication of the search results in prior art search systems,

FIG. 6 is a flow chart showing the application of productmaster filtering in an embodiment of the present invention,

FIG. 7 is a flow chart showing how productmaster filtering is derived in a second embodiment of the present invention,

FIG. 8 is a flow chart showing how productmaster filtering is derived in a third embodiment of the present invention,

FIG. 9 is a screen shot showing a first set of one thousand search results,

FIG. 10 is a screen shot showing a paginated set of search results displayed in traditional systems,

FIG. 11 is a flow chart depicting pricing of a product in a travel distribution channel in the present invention,

FIG. 12 is a block diagram depicting the commissions, discounts and markups applied to travel products,

FIG. 13 is a first example illustrating the use of a hierarchical table of rules in predictive pricing in the present invention,

FIG. 14 is a second example showing the use of a hierarchical table of rules in predictive pricing in the present invention,

FIG. 15 is a third example showing the use of a hierarchical table of rules in predictive pricing in the present invention,

FIG. 16 is an example of how the predictive pricing rules are implemented,

FIG. 17 is an example of how four levels of predictive rules are implemented,

FIG. 18 is a depiction of the fields available in the service entity and associated examples

FIG. 19 is a simplified schematic showing the components of the present invention,

FIG. 20 is diagram depicting the components of the predictive currency module,

FIG. 21 is a schematic diagram depicting the network infrastructure,

FIG. 22 is a diagram depicting the application of the predictive pricing rules,

FIG. 23 is a screen shot depicting the customisable interface of the search engine,

FIG. 24 is a depiction of the fields available in the region entities,

FIG. 25 is a depiction of the lists available in the destination cache and associated examples, and

FIG. 26 is a depiction of the destinational hierarchy and an associated example.

### MODES FOR CARRYING OUT THE INVENTION

In the present specification the following terms are taken to have the following meaning:
“Supplier”: an entity in the travel distribution chain defined as the seller of a travel product to another entity in the travel distribution chain.
“Agency”; an entity in the travel distribution chain defined as the buyer of a travel product to another entity in the travel distribution chain.
“Wholesaler”: an entity in the travel distribution chain who buys a travel product from an entity in the travel distribution chain and sells to another entity in the travel distribution chain.
“Operator”: the proprietor and/or owner of the system according to the present invention.

The present invention provides for a booking engine which incorporates a selection of modules that uniquely combine to provide a single screen booking solution. It is a stand alone system purpose built for sourcing, procuring and distributing individual or packaged travel components, executing bookings and creating travel and accounting documentation for those bookings in an automated process.

It is a fully integrated multi-user, multi-channel reservations system addressing all components of the travel booking experience and can be deployed by any of the previously mentioned entities that are in the travel distribution chain.

The system is distributed using an application service provider model in which all data is hosted stored and backed up by the operators of the system and secure access to the system is by software loaded onto hardware connected to a network and by using an assigned log-in and password.

Indeed, the software used for accessing the system described herein can be provided in a standalone application for running on a PC, PDA, or it can be provided through the functionality of web browsers, including internet enabled mobile devices, through browsers and/or software on a mobile phone, or indeed, via SMS on mobile phones. Alternatively the data can be output in a raw XML data format to third party applications for integration with their systems.

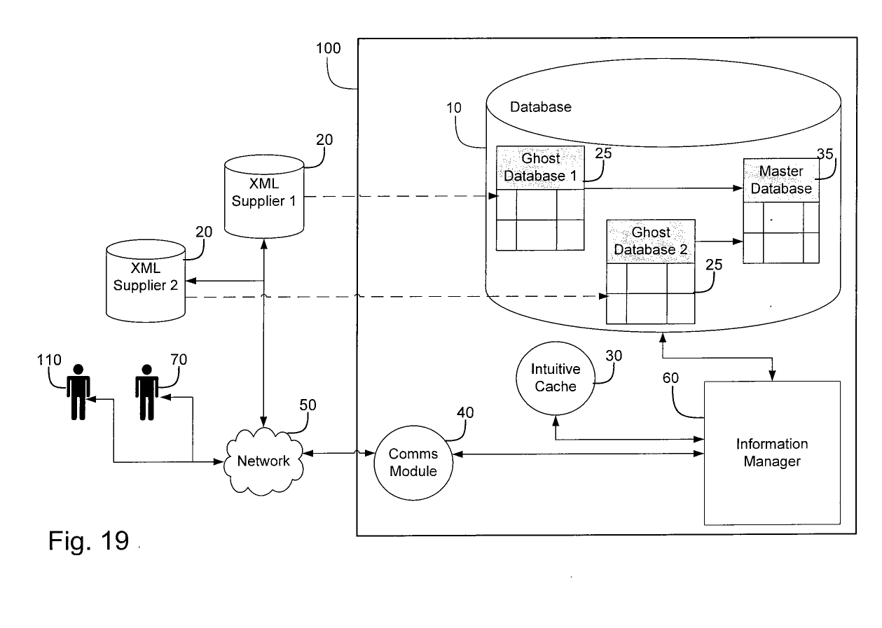

Referring to FIG. 19, the main components of the system 100 include a datastore 10 which contains at least, a table of rules, registration and user details which are components of master database 35, and ghost databases 25. The system 100 further includes a database cache 30 for storing search results temporarily. The system 100 also includes a communications module 40 for communicating with external databases 20 which contain travel inventory, over network 50, as well as users 70 connected to the system 100 via the network 50. The system further comprises an information manager 60 which controls the communication module and which applies the rules and conducts the searches of the external databases 20.

The datastore 10 may contain travel product inventory within master database 35, or in addition or alternatively product inventory can be derived from other external databases 20. However, in the case where external databases 20 are used, in order to maximise efficiency of the system 100, ghost databases 25 of external databases 20 are formed within the datastore 10, by information manager 60. These ghost databases 25 are replicas or mirrors of the external databases 20 and are compiled and maintained as a result of the information manager 60 polling the individual external databases 20 for their contained information at regular intervals through communications module 40 and over network 50. The network 50 can be any network; however it is preferable that it is a TCP/IP network, and even more preferably, the Internet.

The master database 35 further comprises a clone of the ghost databases 25 which forms part of the product inventory that is resident within the datastore 10.

Whilst the methodology of performing the invention will be provided in greater detail further below, an outline of the process of searching datastore 10 follows.

Firstly, there is a search conducted, the results of which are interpreted and prices calculated by the system, after the prices have been calculated for that particular user they are run through a module which eliminates duplication and returns to the user a simplified list of products available for purchase.

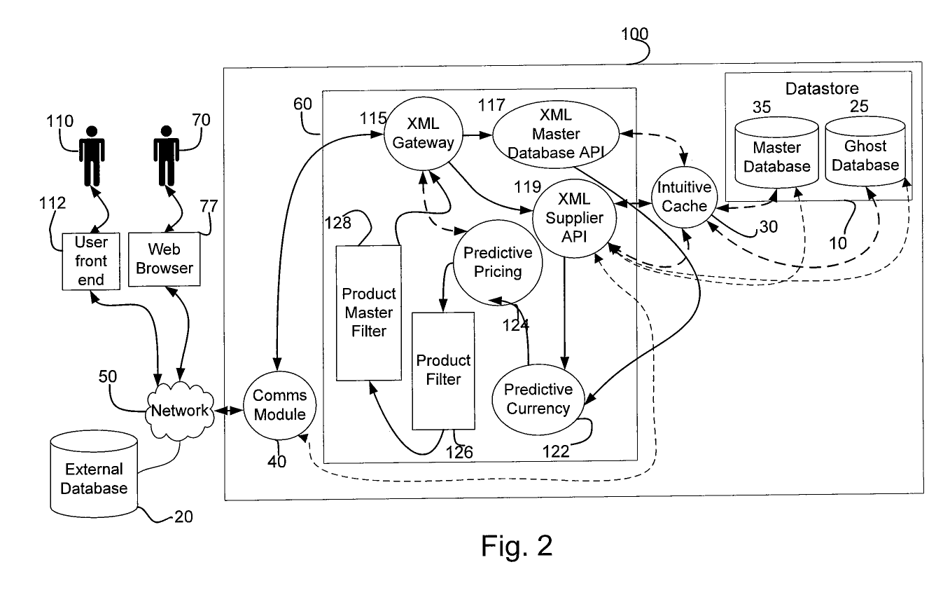

FIG. 2, which depicts one particular embodiment of the invention, depicts two separate users 70 and 110 searching for product utilising the inventive methodology. The user 70 accesses system 100 through a standard web browser, and may represent a consumer, a travel agent, or a consultant. The user 110 accesses system 100 through their own proprietary front end 112, which is able to accept the raw XML data output from system 100 for display through their system.

With respect to user 70 accessing the system 100 via standard web browsers the user logs in or is otherwise identified to the system and then subsequently they enter search criteria for querying the system 100. If the operator of system 100 opens it up to the general public through a web based browser the system 100 would assign all such users a particular “identity” for example, “public” as they would not be pre-registered or have an assigned login name and password through which the system would otherwise identify the user of the system. Thus the requirement to assign an identity to all users is still met, even in the case of unregistered users.

The search criteria entered by the users 70 or 110 of the system are analysed by the XML gateway 115 of information manager 60 which first determines which XML APIs to connect to in order to perform the search through a service map which is constructed at the time the external databases are added and which identify the potential contents of the external databases 20. XML APIs for suppliers such as XML API for a supplier 119 are contained within information manager 60 and one will exist for each external database 20. There is no limit to the number of XML APIs and external databases 20 that the XML gateway 115 can query. Master database 35 will always be queried by XML gateway 115 as it represents the client's main inventory database.

The XML gateway 115 having identified the XML APIs of interest, including the XML API for master database 35, will then send a query each of the XML APIs associated with the databases of interest.

At this point, each XML Supplier API 119 would ordinarily query the master database 35 and the ghost database 25 that is associated with the external database 20 and XML supplier API 119, to determine the products that are potentially available in conformity with the initial search criteria. In particular, the XML Supplier API 119 queries the master database 35 to retrieve the selectionID associated with the product which meets the search criteria. Further, the XML Supplier API 119 uses the results of the search of the master database 35 to identify the corresponding references in the ghost database 25 which mirrors the external database 20. Once the potential available products have been identified in the inventory of the external database 20, the XML supplier API 119 would conduct a quick look up in the cache 30 before querying the external database 20 via a synchronous or an asynchronous query (where a query may in fact comprise multiple queries) through communications module 40 and the network 50 to the external database 20 to determine actual availability and/or price of the products. Alternatively, it is possible to not take the further step of accessing the external database 20 after querying the ghost database 25, if the XML supplier API 119 is set up to not require it, because up to date information is provided periodically which is incorporated into the ghost database 25 which keeps the data accurate and obviates the need to access the external database 20 itself. Once this information is returned to XML supplier API 119, XML supplier API 119 then queries the cache 30 for the full product description which is not returned during the initial search of the external database 20, as leaving the product description out of the query itself speeds up the process of obtaining the information relating to availability and price of a product.

At the same time the XML supplier API 119 is querying ghost database 25 and external database 20, the XML master database API 117 conducts a first query of the intuitive cache 30 for products matching the criteria. If there are no results in the cache 30 which satisfy the search criteria, the XML master database API 117 queries master database 35 to obtain relevant product information.

At this point the returned search results obtained by XML master database API 117 and XML supplier API 119 are sent to the predictive currency module 122 and predictive pricing module 124, both of which form part of information manager 60. In addition, in all instances, all returned search results are stored in the intuitive cache 30 for future reference.

The first processing step of the raw search results involves the Predictive Currency module 122, which “adjusts” pricing to reflect purchases from suppliers buying product in one currency and selling in another and enables the application of currency hedges, set buy and sell rates. For instance the predictive currency module 122 identifies whether a product is quoted in a foreign currency by a particular supplier, and the end user has requested the product price be provided in Australian dollars. In such a case a particular rate of exchange is applied. In order to do that, the predictive currency module 122 then utilises a specially designed mechanism for calculating the applicable rate of exchange. This is explained in further detail below.

Referring to FIG. 2, the predictive pricing module 124 of the information manager 60 then applies the pricing rules, over the search results after the currency processing. The predictive pricing module 124 applies the appropriate rules applicable to each of the users making the search relative to their relationship with the particular supplier and calculates the price that will apply for each of the products returned from the search.

Referring back to FIG. 2, the information manager 60 then carries out the step of applying the product filter module 126 to sort multiple returns of the same product and separate the results according to the criteria applicable.

After the product filter module 126 has been applied to the search results, productmaster filter module 128 is then applied. The productmaster filter module 128 consolidates the search results list even further, by grouping the search results by product, and thereby, grouping multiple instances of suppliers supplying a particular property under one listing for that property. No information is lost, rather, the two or more suppliers per product are grouped together.

Once the search results have been processed, they are published via communications module 40 and network 50 either to web-browser 77 for user 70 or to the user front end 112 in the form of raw XML data which is interpreted by the user's front end 112 and displayed on the system of user 110. As one of the search criteria is the identity of the user, the prices returned to the users of system 100 will reflect their own unique pricing and remuneration arrangements for the particular product.

During the process, the system 100 checks search requests against data held within cache. Using intuitive caching technology the system 100 is able to identify potentially relevant results in the cache 30 from previous searches, and thereby substantially speed up the response times for search requests.

### Predictive Search

The system uses a generic search, termed the universal search routine. This routine is the same for anyone wishing to conduct a search across the available data that is presented. The routine has been split into distinct stages, each of which does not necessarily have to follow in that order. The nature of the travel industry is such that there are many starting points for searching travel inventor. The search engine built into system 100 has been configured to deal with more than one of these.

The fundamental requirement in beginning a search is to derive a set of criteria upon which the search can be initiated. The criteria can include the following fields.
(i) agencyId: this defines who is searching. The agencyId is essential in driving what selling currency is to be presented, and is a factor in what product is displayed and what price is presented.
(ii) destination: the destination is defined as either a country, region, city, locality or airport (in that hierarchical order). At present, a city must be defined in the search to limit the search results to a manageable level. For example, a search for hotels in “Sydney” may return 100 results, which a user may choose to read 5, but a search for hotels in “Australia” will return well over 1000 results, which is simply too much unfiltered data to for a normal user to digest. In one embodiment the destination search criteria was entered by the user through using 2 separate drop down boxes; a country drop down and a city drop down. The use of drop downs can be time consuming however, as every time each box was loaded onto the screen, about 100 countries and other destinations needed to be loaded. This could be worked around by use of AJAX retrieve the countries, but that doesn't eliminate the fact the “Azerbaijan” is always loaded in some way. In a further embodiment of the invention a local cache is which while simple enough to implement, still had to be loaded once per session. In the preferred embodiment of the invention, the two boxes are replaced by a single destination box that downloaded only upon keydown, much like the Google Suggest tool (now this tool is referred to as an AJAX autocomplete, as opposed to an autocomplete which is used to describe the browser's tool). The destination box loads matching data from a cached destination hierarchy and sends them back to the user's screen. Moreover, these values are cached on the user's side so that if they backspace, and retype the same letters, the data is retrieved from their cache rather than resending the same AJAX commands again, thus saving on processing time and resulting in a faster user interface.
(iii) fromDate/toDate: the basis behind a travel search is always date related. If dates are not provided, then the user is simply browsing, and the user should not expect any prices; simply a description database which they can read. This has been another type of entry point discussed that they system can be adapted to. Another entry point has been the concept “searchByMonth”, which has been used by the system to describe how the user searches for travel services such as extended multi-day tours and cruise voyages. Because these services generally span a fixed period of time (for example, a 8 day/7 night cruise), they inherently have fixed dates of departure. For example, a fortnightly cruise aboard the cruise ship “Queen Mary 2” can only depart once every fortnight, as there is only one ship! Thus, in any given month, there is at most 2 departures. If the search engine criteria was rigid in requiring the user to enter the specified departure date, it is highly unlikely that the user knows what day of the month that the cruise departs on. Thus, the ensuing search is not truly indicative of what is available; the generally accepted search criteria for these types of services is to browse a general time period to see what is available for departure over a range of dates. The system uses “searchByMonth”, but this can easily be modified to take in a range of departure dates instead.
(iv) passengerConfiguration: is required to determine the price basis of the products that are found in the search. Passenger configuration is very important as within travel, pricing of a travel service is not a straight forward as multiplying the single passenger price by the number of passengers attending. Thus, in order to display an indicative price, the search criteria requires an indicative number of passengers. One of key features of the search engine is that the passenger configuration can be changed at a later stage within the search process, thus allowing the user to truly “browse” the prices. For example, the user might initiate a search for 2 Adults, and get a price returned for a sightseeing tour for $100 in total. When the user selects the tour, the user sees a special family pass in the description. They can change their passenger configuration to bring the whole family; they change the passenger configuration to 2 Adults and 2 Children, and the price changes to $160 in total immediately (this dynamic price change is achieved through AJAX), without having to reinitiate another search. The user accepts the price and books the service.

One of the most challenging problems is how to encapsulate a search engine that can cater for all the different types of travel services into the one user interface. We have already mentioned that hotels require check-in and check-out dates; cruise searches use a “searchByMonth” which does not specific any specific dates; sightseeing tours simply use a single tour date; car hire does not use passenger configurations at all; etc. The nature of travel means that there has been no single search engine that can deliver all the differing travel services in a single user interface. The system achieves this complex task by defined each of the services as a “service” entity within the database. Each service can then be modified by simply turning flags on and off.

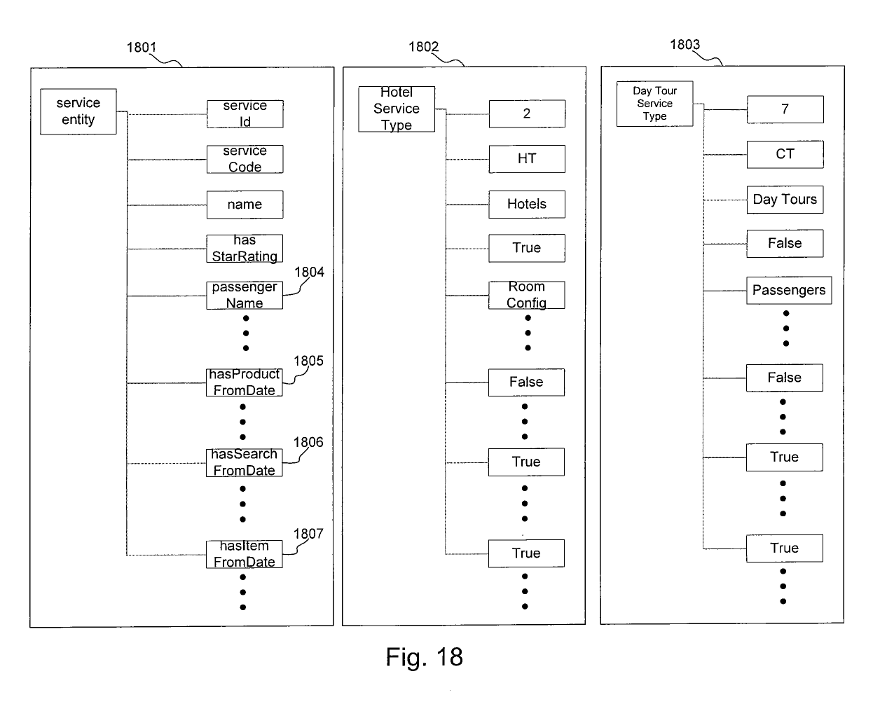

An example of the data structure of a service entity can be seen in FIG. 18, where service entity 1801 is depicted with its fields, and in particular, example fields 1804 representing a name configuration field, example field 1805 which represents a product configuration field, example field 1806 which represents a search configuration field, and example field 1807 which represents an item configuration field. Example service entities 1802 and 1803 represent service entity 1801 with data inserted into the field which are applicable for that particular service type. For example, service entity 1802 has been configured in respect of hotel product.

This addressed one of the failing points of other systems in that they had different interfaces for different service types which you would have to navigate to typically by clicking on another link and loading up a new page; in reality you are actually entering another third-party system dedicated at searching a specific service type. The invention solves this problem by coding to the service entity, and based on the configuration flags of the service, certain criteria boxes would appear and disappear, and labels will change to suit the context of the service type.

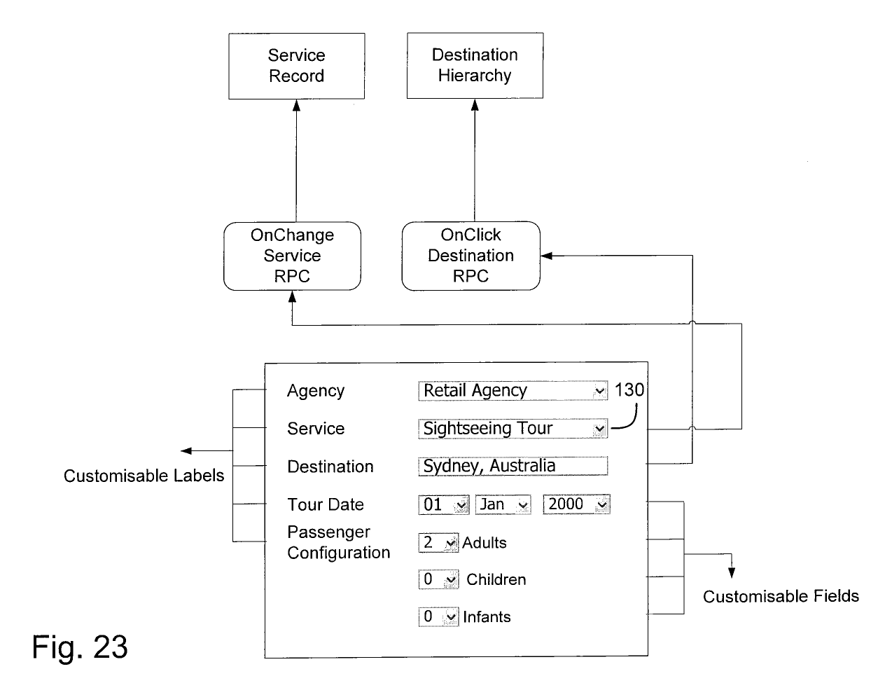

This is demonstrated in FIG. 23 where changes made to the service field 130 will cause a change in the service record which may in turn alter the customisable labels and customisable fields in the search interface.

As mentioned, the entry points can be quite varied and adaptable; this is one of the key driving forces behind the technological development. As such, the technologies behind the search process allow the routine to be flexible enough to be adapted to other entry points. This has been highlighted by the fact that the search engine has been extended to incorporate web service enabled calls with minimal effort. Other extensions that have taken place include, but are not limited to:
(a) direct product searching: which effectively allows a user to focus their marketing on key product within their business. They are able to promote individual products within their system, perform agency specific searching or control globally accessible brand access. To achieve this, the search engine was adapted to take in a unique selectionID that can represent either a Productmaster, a Product, or a Subproduct, thus allowing the user to expose a single hotel, or even as far as a special room type from a selected hotel.
(b) product theme searching: which allows the products within the product database to be grouped together into logically sets based on its target market. For example, a honeymoon theme can be defined, and within it, hotels from France, villas from Italy, resorts from Tahiti and tours of the Maldives can be lumped together into this product theme. Thus, this removes the requirement of a destination from the search. This entry point is more geared towards leisure browsers who have a specific need to fulfill in their holiday, but are unsure or not too concerned about the destination.
(c) white label: the use of the agencyId has been extended to provide for a white label interface for agents. This white label is effectively the systems search engine, wrapped in a CSS layer, with customizable content around its sides so it has the look and feel of an agent's web site. This has the effect of increasing the wholesalers distribution methods by effectively “implanting” their search engine into agent's websites. The dilemma at present with agent's websites is that agent's have little or no technology to offer a consumer search engine to their clients. Many agents at present utilize links to aggregator websites, with their agencyId, so that their commission can be tracked, but they employ the use of 3 or 4 links as these aggregator websites are generally serving single service types. Some of these links are not skinned appropriately to the agent, and do not portray the brand image that they wish.
(d) private label: this term describes the white label behind a login only process. This entry point was added so that the search engine can be tailored like a white label, but presented to a closed user group such as a charity, or a staff incentives website, etc. By being behind a login, or an intranet, it is effectively closed to the public, and the prices displayed can be more attractive than published rates.

Once the search criteria is collated, it is returned to the search engine, which then proceeds to process the data and distribute synchronous or asynchronous queries to the relevant components of the system. This is one of the key driving points in the system, as it must deliver a set of common results from a number of different sources in a timely manner to the end user.

### Destinations

The concept of a destination is used to describe a travel location in an accurate and consistent manner. This was to address a deficiency in the prior art where inaccurate or non-specific destination information is a barrier to increased sales For example, the hotel “Sheraton on the Park” is located in the city “Sydney”; the hotel “Radisson” is located in the city “Sydney”. However, the more travel knowledge the user had, the more fine grained the search tended to become. For example, a travel agent knows that if their client wished to stay near the airport, then they would prefer the “Radisson” over the “Sheraton on the Park”. However, the average user would not know this information immediately from the search results unless they read each of the hotels' descriptions. When faced with over 100+ hotels in the city of “Sydney”, however, the average user would not be reading every hotel's description; and thus may abandon the search and a sale is thereby potentially lost.

Thus, there was a need for a generic destination description which allows a fine-grained search to be conducted so that travel-savvy users could filter their search specifically to what they wanted. In order for the system to accommodate this, a flexible destination hierarchy needed to be created.

In the present embodiment of the invention there is provided a destination hierarchy with three fixed sets of layers and two flexible layers of hierarchy. The ‘country’ was deemed as the highest level within the hierarchy. There would be little point in grouping countries together into continents, or zones. It was felt that this was a subjective grouping, and to do so would lead to more arguments over its correctness, and never resolve amongst a random set of users. For example, “Oceania” is generally used to describe Australia and parts of South East Asia, but one may decide to use “Asia Pacific”, which encompasses more than Oceania. Neither is right nor wrong, but it would be difficult to get two people with different opinions to agree on which was “more correct”. As such, the country level was set as the highest in the destination hierarchy, and set as a fixed layer that generally could not be changed.

The second fixed layer in the destination hierarchy is the city layer. This is more subjective than the country, as the term city can be misleading. Theoretically, “Parramatta” and “Ashfield” are cities based on their population and geography, and yet both are readily deemed as suburbs of the city “Sydney”. In travel terms, a city is normally associated as one with a 3-letter IATA code; such is the heavy reliance on aeronautical travel as 3-letter IATA codes are historically assigned to airports. This has become less agreed upon in recent times, as the city “Bath” in the country “United Kingdom” does not have a 3-letter IATA code because it lacks an airport, yet it is most definitely thought of as a city. At present there are 2 generally accepted standards for defining cities. IATA codes have expanded beyond airports and now incorporate cities, car depots, cruise ports, etc. Normally where there is a depot or port, there is a community, and hence some tourism of sorts. As IATA codes are well known amongst the travel industry, this is the more accepted standard today. The second, lesser known standard, ICAO, is defined by the International Civil Aviation Organisation, and is used predominantly by air traffic control and flight planning operations. ICAO codes are also 4-letter codes, which allow much greater room for future expansion. IATA codes, at 3-letters, will only allow for 26×26×26=17575 alpha cities, or 36*36*36=46656 alphanumeric cities. ICAO codes, at 4-letters, will allow for a much greater number of cities. The term “city” used here in this context also includes individual airports. Hence, the city “Paris” has the IATA code “PAR”, but no defined ICAO code, but within Paris there are 5 airports, each of which has their own respective IATA code and ICAO code. Thus, while at first glance, 20000 cities sounds plentiful, in practice IATA codes are fast approaching its size limitations especially when we include bus depots, train stations and cruise ports. If we were to map every possible city in the world, we believe we would exceed 20000 quite easily.

Recognising the fundamental issues surrounding cities within the travel industry, it was decided that a standard needed to be adapted, yet this needed to be flexible enough to change in time if required. Flexibility is achieved by enforcing all tables to be keyed by an integer rather than an alphanumeric code; this allows the code to be changed in the future without affecting foreign keys within the database, so long as the newly selected code is unique (a unique key index is always created with table codes). On top of that, all codes are generally set at 32 varchar, though this value can be expanded easily if required with little software repercussions due to the flexibility of the database. As a general rule, the IATA codes have been adopted where known, and for lesser known cities, a pseudo code has been assigned. For example, “Bath” has no IATA airport code, but it has “FGW” assigned as its IATA railway code, so this has been used.

The third fixed layer, which we have already touched upon, is the airport layer. Again, there is a finite set of airports within the world, and fortunately these have been well described and documented in the two standards, IATA and ICAO. While new airports are constantly being created, the standards are generally up to date. The reliance on the GDS these days requires most travel consultants to know the most common airport codes off by heart, and until there is a major shift away from the GDS, this trend will most likely stay. For example, “JFK” is known as John F. Kennedy airport, and most travel consultants know this. In an alternate embodiment of the invention, particularly in the case where the operator is relatively uninterested in air travel, the airport level of the destinational hierarchy may in fact be made optional, leaving only two fixed destinational levels, being the country and the city.

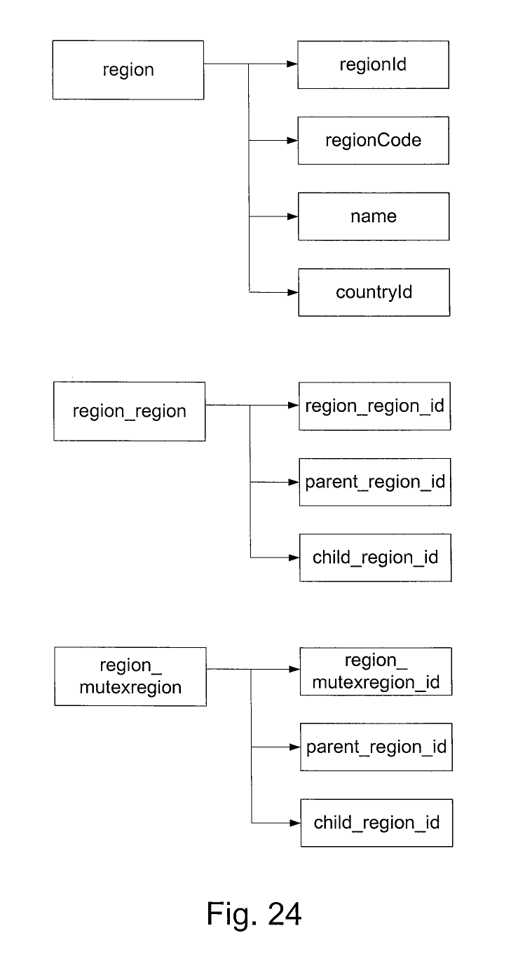

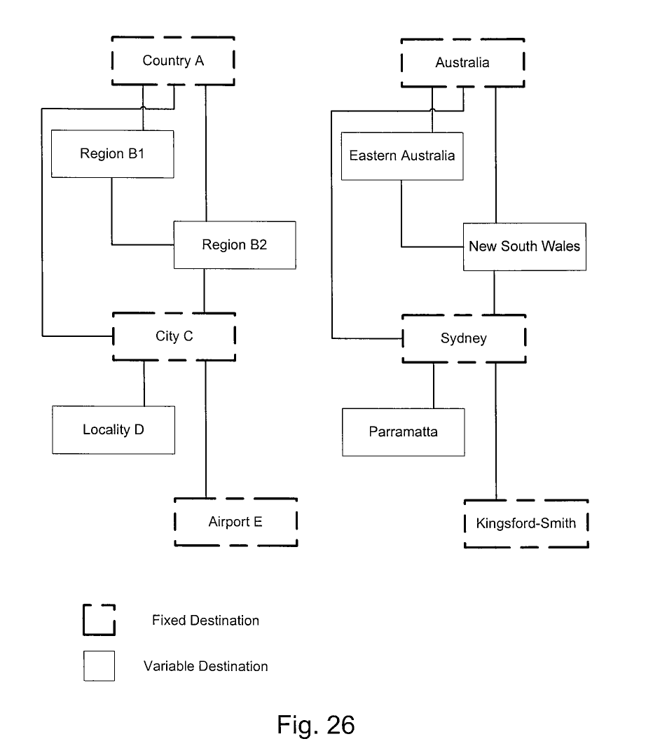

The other two layers are left empty and as “customizations” that the software user can choose to use (if they wish to maintain a richer and more fine grained set of destination information) or ignore (if they do not wish to invest the time to maintain this). One of these layers is the “region”, which effectively group cities together into more logical and well known areas. For example, “Tuscany” is not a city nor country, but rather an area that incorporates many cities, but due to the marketing of the region, the average punter knows “Tuscany”, but would not know “Montecatini”, which is a major city within “Tuscany”. The unique design of the region table design is that it has a foreign key back to itself; thus this is termed as an n-level hierarchy and it's structure can be seen in FIG. 24. While all the other layers are single layers (for example, a city cannot exist within a city; an airport cannot exist within an airport), the region differs in that it can exist within another region as depicted in FIG. 26, where the “New South Wales” region exists within the region of “Eastern Australia”. Because the region can be thought of as a group, you can design regions such that there are groups within groups. The cumulative set of cities within a region and the cities within its subregions are defined as the set of cities that belong to that region. In order to properly allow control of city sets within a region, we also included a tabled called “region_mutexregion” which would allow you to mutually exclude one region from another region. This represents the ability to have a region that intersects with another region, but does not wholly union that region's set.

The other flexible destination layer is the “locality” level, which sits underneath a “city”. This allows the software user to create specialized areas within a city that are important to their clientele. For example, assigning the hotel “Radisson” to the locality “Kingsford-Smith” within the city “Sydney”, and the hotel “Sheraton On The Park” to the locality “CBD” within the city “Sydney” will allow the search engine to bring back both results for a search in city “Sydney”, yet allow a more advanced or knowledgeable user to filter this down to a single result for a search in the locality “Kingsford-Smith” in the city “Sydney”.

As a general rule of thumb, destination specialists such as a Canadian travel specialist would invest the extra effort in establishing the popular tourist places within Canada as their clientele would demand such fine grained knowledge and search abilities, while a global aggregator concentrates more on volume, and would not be as detailed as a destination specialist.

The concept of fixed destinations is to represent the generally static nature of the world's destinations, in particular the consistency of the world's countries, cities and airports. Regardless of what system is analysed, it is more often than not that the basis of the destination component of that system relies on the existence of a “city” record, which inherently means the presence and existence of a “country” record. In systems that are more geared towards flights and aeronautical travel, there is a reliance on GDS inventory, which in turn means there needs to be the existence of the “airport” record. For example, “SYD” is probably one common code across all travel systems, and more often than not this would point to the city “Sydney”.

The introduction of the variable and hierarchical destinations in the invention allows the operator to effectively fine-tune the world's destinations as they see fit.

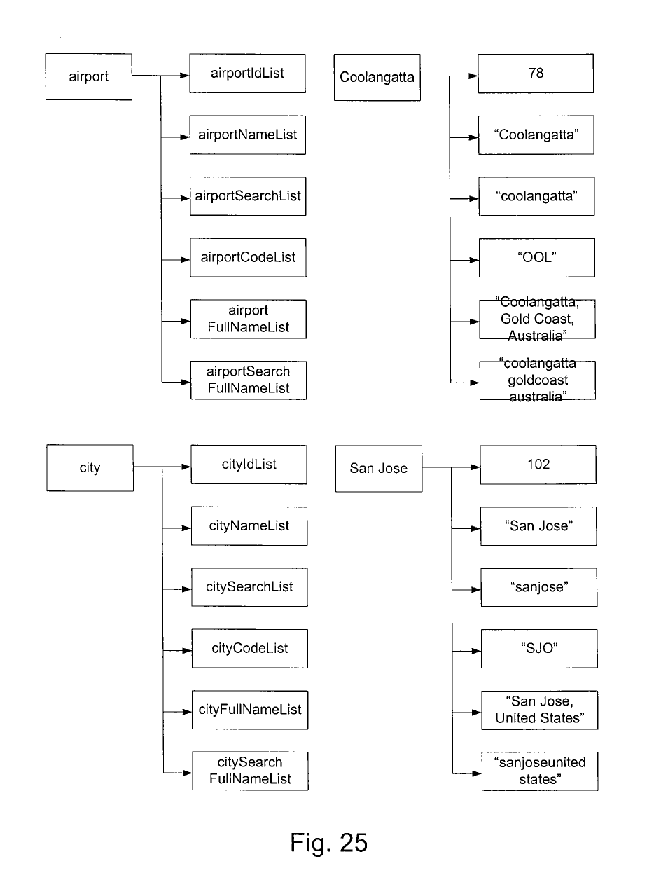

In order to more efficiently search through the destination hierarchy, it was found that by doing SQL selects every time we required it, a lookup was too slow, considering the amount of data to be looked up. In a preferred embodiment of the invention a cache is employed. Further in a preferred embodiment of the invention a simple one dimensional cache would be insufficient for the purposes of identifying a destination out of a large number of destination. Thus a cache with some logic was utilised to speed searches up. For example, in order for the system 100 to be able to identify destinations that have some variability in their names, a one-dimension cache would miss certain variations. In order to overcome this problem, in the most preferred embodiment, system 100 employs a cache that has multiple lists for each of the five destinational levels, as depicted in FIG. 25 where two destinational levels are depicted; airport and city. For each of these destinational levels, six lists are indicated alongside two example entries for “Coolongatta” and “San Jose” which demonstrate the content of the lists at a fixed index (i.e. position). The index of the record is used to jump between the other lists.

Thus we are effectively caching the important fields (or derivatives of the fields) into lists. One of the important features of the naming is that the comma “,” is used as a delimiter, and thus tells us whether the result is a country (no commas), a city (one comma) or a locality (2 commas)—this is important in the building of the fullName component. From the search perspective, the most important aspect is the searchName, and the fullSearchName, which produces the following results (see FIG. 25). The searchName and the fullSearchName are case insensitive, alphanumeric only results based on the name and the fullName. Thus, the city “San Jose, United States” would appear if the user typed in any of the following values into the destination box:
“san”
“san jose”
“sanjos”
“jose”
“jo se”
“jose, united states”
“sanjose-united states”

In order to achieve this, the user's value is turned into an alphanumeric value, stripping it of all spaces and commas and invalid characters. It is lower cased so that the search will be case insensitive. It is then compared against the cached fullSearchName list to try to find any match against the value. If any value is found, the corresponding index of the list is used to determine if the city is active, and if so, the full name is retrieved. This is done until the entire fullSearchList is exhausted, by which time we have a results set to return back to the user through AJAX, thus populating their destination AJAX autocomplete box.

This process is marginally slower than the traditional method of one dimensional caches, but much faster the SQL lookups. It will also require a larger amount of memory as more cached lists are required to achieve the additional logic we need; however it is this logic that makes the cache more “intuitive”. It is also flexible as we can add more intuitive lists (to the ones depicted in FIG. 25). One additional list is the “soundex” list which is effectively a phonetic search. This takes a string value, say “Sydney”, and converts that into a syllable encoded string, say “S30N18”. S30 and N13 represent ways of pronouncing syllables starting with the leading consonant. This is the same syllable encoded string as “Sidnee”, as they are pronounced in identical fashion. This will enable us to return the result “Sydney” to a user who actually typed in “sidnee”, or “sid knee”, or derivatives to that effect.

### Predictive Pricing

The predictive pricing step is a unique method that allows multiple levels of control over the pricing of a single product depending on the channel in which the product has been sold.

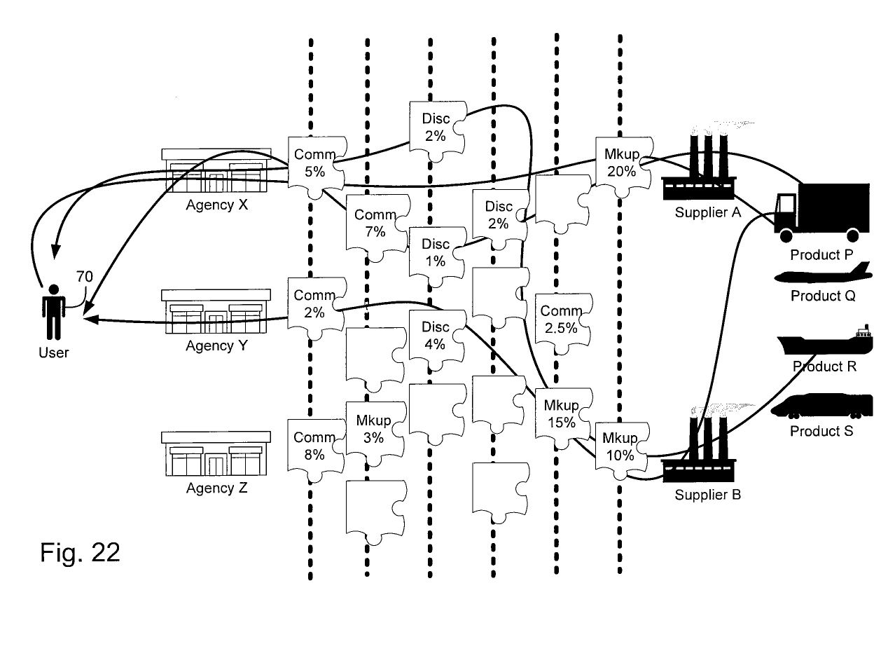

FIG. 22 depicts a number of products which are in turn supplied by various suppliers. The novel aspect of this system 100, is that the final price payable by a user for a product is dependent on the path taken and the intermediaries involved. Each unique product channel combination has it's own potentially unique combination of rules, as shown in FIG. 22.

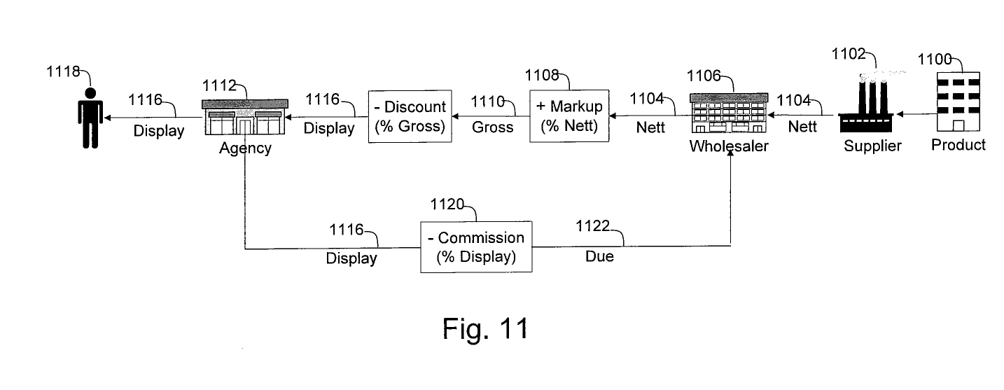

To explain the concept of predictive pricing, a simplified example of how the final price of a product may be derived from its supplier to the consumer is shown in FIG. 11. The parties involved in this distribution channel include the supplier 1102, wholesaler 1106, travel agency 1112 and consumer 1118. Initially, the supplier 1102 offers the product 1100 to the wholesaler 1106 for a nett amount 1104. In an attempt to make a profit, the wholesaler 1106 would then mark this amount up which becomes the gross amount 1110 or in order words the Recommended Retail Price (RRP) of the product 1100 that is made known to the consumer 1118, though as seen, is not necessarily the price paid by the consumer 1118. The actual product 1110 is typically sold to the consumer 1118 through travel agency 1112, who may be given a discount 1114 off the gross amount 1110. This becomes the display price paid by the consumer 1118. As mentioned in the background, travel agencies 1112 are also rewarded for their services by way of commission payments 1120. Therefore the due amount 1112 to the wholesaler 1106 for a product 1100 through a travel agency 1112 is equal to the display amount 1116, less the agency commission amount 1120.

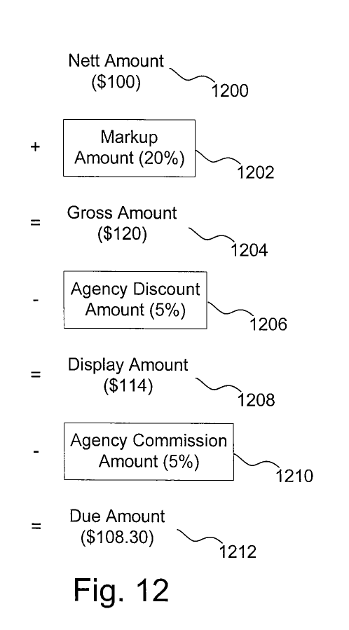

Another example with monetary values is illustrated in FIG. 12. In this example, the wholesaler buys the product from the supplier for a nett amount of $100. The wholesaler then increases this initial nett amount by a 20% markup to get a gross price of $120. The wholesaler 1106 chooses to give a 5% discount on this Recommended Retail Price to the travel agency 1112. The agency 1112 is rewarded with 5% commission for their services from the wholesaler 1106, so therefore the wholesaler 1106 eventually receives a due amount of $108.30. Essentially, this means the wholesaler will make a profit of $8.30 each time this particular product is sold.

As can be seen by the summary in FIG. 12, the main components that may affect the price of the product include the markup amount, agency discount amount and agency commission amount. Once these values have been set, the price of the product sold in relation to a particular distribution channel can be determined. In the predictive pricing method, these components make up a “rule”. However, these rules are not limited to the three components mentioned above and do not have to apply at a specific product level.

The rules may be set at a broader level influencing the price of more than one product/channel. For example, a wholesaler may want to markup the nett price of all the products they have bought from a specific supplier by 20%. An agency may want to put a 5% discount on the gross price for all accommodation products from a specific supplier. While an agency may receive a 5% commission on the display price for any products they sell.

On the other hand, the rules may be set at a very strict level influencing the price of a specific product under certain conditions. For example, an agency may choose to give a 5% discount on a particular multi-day tour product only if it starts on 1 Mar. 2008.

Therefore some rules may overlap at certain levels and each product/channel may eventually have more than one related “rule” and thus more than one applicable markup amount, agency discount amount and agency commission amount. The invention's predictive pricing method represents this through the use of a hierarchical table of “rules” for each product/channel. The table is hierarchical in the sense that the rules have an order of precedence, where the components of the “higher” rules are used over “lower” rules.

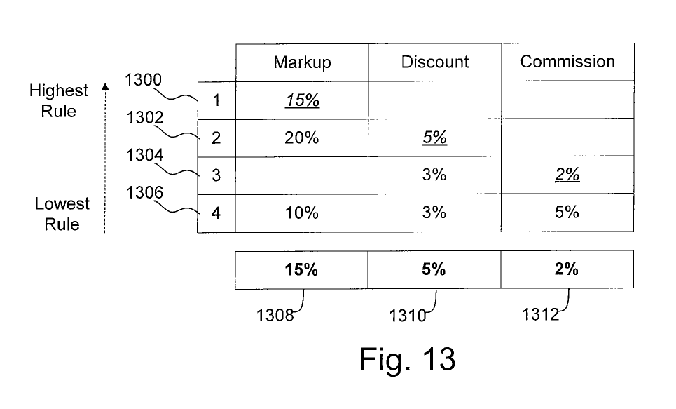

FIG. 13 illustrates an example of how the predictive pricing method may use the hierarchical table to derive a single set of rule components, which will be used to calculate the price of a product/channel. In this example, the product/channel has a table of four related rules where first rule 1300 has the highest precedence and fourth rule 1306 has the lowest precedence. Predictive pricing will go through all the rules sequentially from highest to lowest precedence and use the first value identified for each component. Therefore, the final markup amount used is 15% as obtained from rule 1, the final agency discount amount used is 5% as obtained from rule 2 and the final agency commission amount used is 2% as obtained from rule 3.

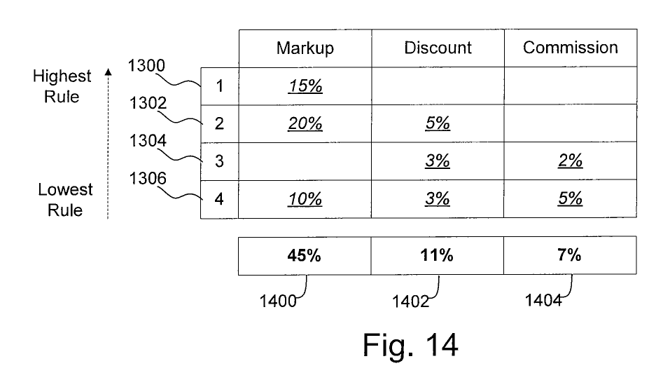

FIG. 13 illustrates an example of absolute predictive pricing, where only one value of each component from a rule is used. FIG. 14 illustrates an example of how predictive pricing may alternatively use the hierarchical table in a cumulative manner. In this example, the value of each component from every related rule is used by accumulating them together. Therefore, the final markup amount used is 45%, the final agency discount used is 11% and the final agency commission amount used is 7%.

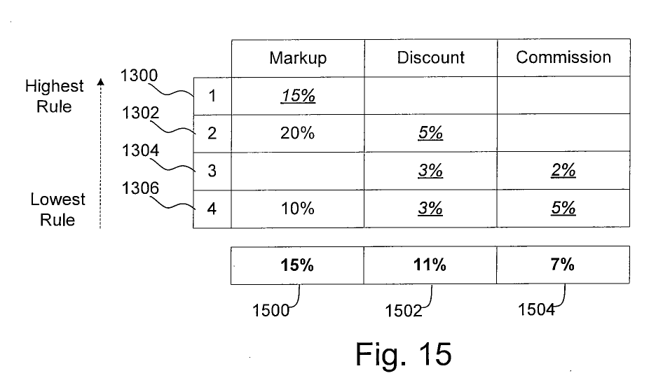

As you can see, one of the benefits of predictive pricing is that it gives the system access to all the relevant rules for a particular product/channel and allows it use them in many possible ways for price calculation. In addition to the absolute and cumulative methods used in FIG. 13 and FIG. 14, the system may also be configured to use a combination of both methods. For example, in FIG. 15 the final markup amount is derived absolutely from rule 1, while the final agency discount and commission amount is accumulated from all four rules.

Predictive pricing is a flexible method in the way that any number of rules (rows) and rule components (columns) may be added or removed to a hierarchical table easily. Similarly, the precedence of the rules may also be reordered in any way.

In one possible implementation, the current invention stores all the rules in a single “Calculation” entity within its database. This entity contains separate database entries that represent a single rule and each one is made up of attributes representing their components i.e. markup amount, agency discount amount and agency commission amount. As mentioned before, in the concept of predictive pricing more components may be added or removed from a rule. This is simply implemented by adding or removing entity attributes.

To implement the rules at different levels, the database maintains a one-to-many relationship between the “Calculation” entity and any other entity that represents a valid rule level.

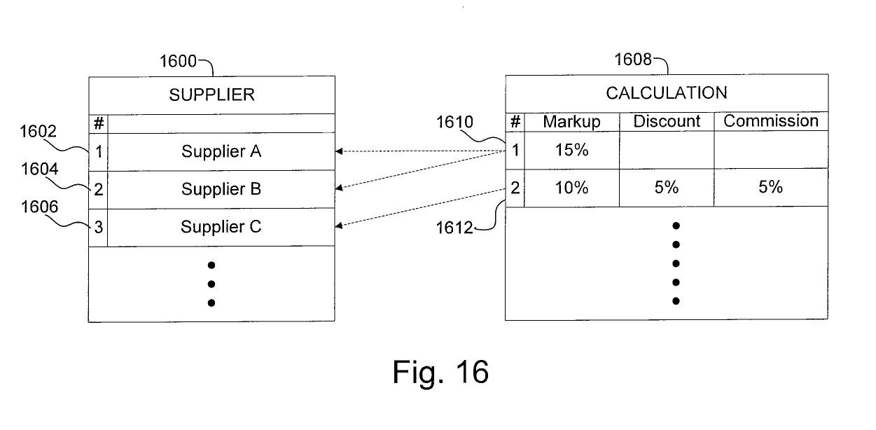

For example, the database may have a one-to-many relationship from the “Calculation” entity to a “Supplier” entity, meaning an instance (i.e. a rule) of the “Calculation” entity could be related to one or more individual suppliers. A rule would generally be applied at this level, if a party wants to fix a component value for all products that are sourced specifically from a supplier. For example, in FIG. 16 the first entry in the “Calculation” entity 1608 represents a rule with a 15% markup amount and it is linked to the first and second entries in the “Supplier” entity 1600. This means the system is configured to markup the nett price for all the products offered by Supplier A 1602 and Supplier B 1604 by 15%. Similarly for the second calculation entry, all products offered by Supplier C 1606 will be marked up by 10%, given a discount of 5% and rewarded a commission of 5% when they are sold.

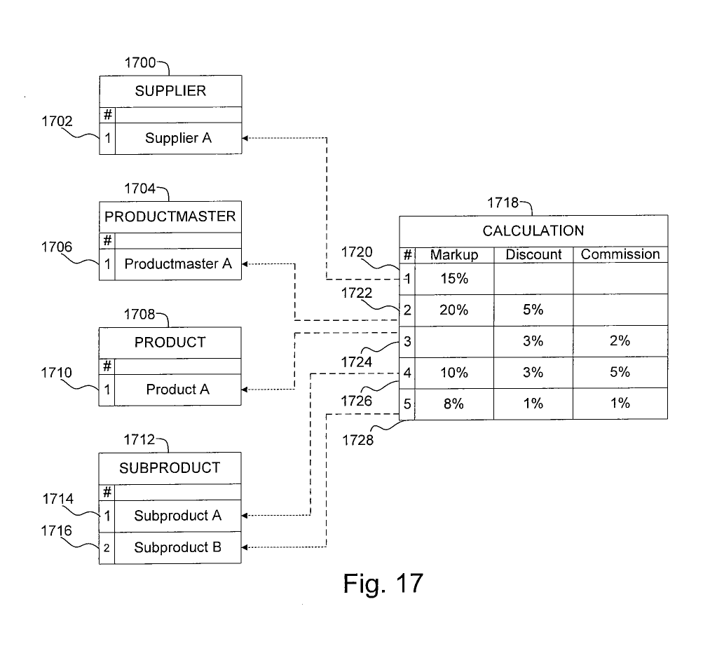

FIG. 17 demonstrates a simple example of how four levels of “rules” may be implemented for a particular product/channel in the invention. In this example, the rules may be implemented in relation to a specific productmaster, product 1708, subproduct 1712 or supplier 1700. Productmaster A 1706 is used to group Product A 1710, which has two variants in Subproduct A 1714 and Subproduct B 1716. Product A 1710 is also sourced from Supplier A 1702. Therefore, if the system wanted to calculate the price for a hotel room that is represented by Subproduct A 1714, it would have to process four applicable “rules”: 1720, 1722, 1724 and 1726. The fourth rule 1726 is directly related to Subproduct A 1714 itself, while rules 1720, 1722 and 1724 are applied by virtue of a relationship at a higher level. For example, rules 1720, 1722 and 1724 are also applicable for Subproduct B 1716. After all the relevant rules have been identified, the system will then determine the correct component values to use, through the use of a hierarchical table of rules and by reference to the manner in which the operator of system 100 has applied rule configurations. In fact, the table to be used for pricing Subproduct A would be the same as the one demonstrated in FIGS. 13-15 if we assume that order of precedence from highest to lowest is: Supplier, Productmaster, Product and then Subproduct rules.

Extra levels of rules can be implemented simply by linking the “Calculation” entity to additional entities. In the current invention, twenty-five levels of rules have been identified and created, though there is no limit to the amount that can be added and there will be minimal impact to the size, structure and performance of the database. They include those detailed in the table shown in the following table, Table 1.

Currently some 25 rules have been identified and created within the hierarchy, though there is no limit to the number that can be added and there will be minimal impact to the size, structure and performance of the database.

TABLE 1
[ITEM] (item table) - This allows you to override values at the time of booking. This can
happen in the event of price matching, on the moment discounts, etc.
[RATE] (rate table) - The calculations can be set at the rate level. This represents
special calculations for a particular tariff.
[SUBPRODUCT] (subproduct table) - This means that the values in this subproduct
take a high level of precedence. This represents calculations for a room, cabin or any
other subproduct variant.
[PRODUCT] (product table) - This means that the values in this product take
precedence over all other lower values. It would be rare for values to be input at this
level, unless a specific product from a specific supplier demands that a fixed value
(markup, discount, commission or otherwise) be used.
[PRODUCTMASTER] (productmaster table) - The productmaster represents a group of
products from multiple suppliers that are really competing to provide a single product.
Values in here are only populated if the product (independent of the supplier) demands
a fixed value.
[PRODUCTCHAIN_SERVICE] (productchain_service table)
[PRODUCTCHAIN] (productchain table) - Similar to the productmaster, but applies to a
set of product instead. For example, if the Hilton chain of hotels demands that all their
product are to be discounted, a value here can enforce such a rule.
[SUPPLIER_SERVICE] (supplier_service table)
[SUPPLIER] (supplier table) - If a supplier demands all his product are to take a fixed
value, it would be set here. This would typically be assigning a fixed markup to an
entire suppliers range.
[SUPPLIERCHAIN_SERVICE] (supplierchain_service table)
[SUPPLIERCHAIN] (supplierchain table) —Similar to the supplier, but applies to a set of
suppliers. If suppliers are set up to use supplier chains, you can control fixed values for
all of them at this level.
[AGENCY_SERVICE] Agency Service (agency_service table)
[AGENCY] Agency (agency table) - If fixed values are negotiated with an agency, this
can be represented at this level. For example, a special agency who puts through a
large percentage of the system can demand a higher commission rate.
[AGENCY_PRICESTRUCTURE_PRODUCT] Agency Product Price Structure (agency
to pricestructure to rate_configuration_pricestructure table) —A product can specify
values for specific price structures. This takes precedence over an agency price
structure.
[AGENCY_PRICESTRUCTURE_SERVICE] Agency Price Structure Service (agency to
pricestructure to pricestructure_service table)
[AGENCY_PRICESTRUCTURE] Agency Price Structure (agency to pricestruct table) -
Agencies can be grouped together under a user defined price structure, such as VIP,
standard, etc. and these price structures can have fixed values.
[AGENCYCHAIN_SERVICE] Agency Chain Service (agencychain_service table)
[AGENCYCHAIN] Agency Chain (agencychain table)
[AGENCYCHAIN PRICESTRUCTURE] Product Agency Chain Price Structure
(agencychain to pricestructure to rate_configuration_pricestructure table) - In a similar
way to the Product Agency Price Structure, this level simply checks if the product has
any overriding values for the agency chain's price structure.
[AGENCYCHAIN_PRICESTRUCTURE_PRODUCT] Agency Chain Product Structure
Service (agencychain to pricestructure to pricestructure_service table)
[AGENCYCHAIN_PRICESTRUCTURE] Agency Chain Price Structure (agencychain to
pricestruct table) - Similar to the agency level, but applies to a set of agencies. For
example, the VIP agencies could be the entire Flight Centre agencies, and you may
want to discount their product across the board.
[MARKET_SERVICE] Market Service (market_service table)
[MARKET] Market (market table) - A market can inherit special values. They can be
set at this level.
[SYSTEM_SERVICE] System Service (system dictionary) - A system wide value
determining the calculation for a particular service.
[SYSTEM] System (system dictionary) - When all else fails, the system dictionary is
used to fill missing values. There should ALWAYS be values in the system dictionary,
as a catch all situation.

### Predictive Currency

Current wholesale and online systems usually provide a single mechanism to apply to foreign exchange rates when converting the currency or acquisition to the calculation required when determining a selling price. This is an especially onerous task when considering that buying prices may be determined up to 12 months in advance, or where selling prices are nominally fixed for 12 months as in a brochure. In the present climate when foreign exchange rates move against a seller, the wholesale market responds with “currency surcharges”.

The competitive forces of the internet have allowed other players to mark the price as a daily price and change prices accordingly, usually resulting in their having a significant price benefit, and/or the fixed price seller being forced to reduce its published price (and margin) to match.

Both techniques suffer from a lack of rigorous allocation of the underlying issue i.e. the rate that I sell at today is a surrogate for the time that the product is to be settled with the supplier, which may be 12 months into the future.

In order to overcome this problem, the system 100 needs to emulate the dynamics of the currency market. The one fundamental component missing from other systems is the ability to model the currency market, and then to apply this model dynamically to a booking real time.

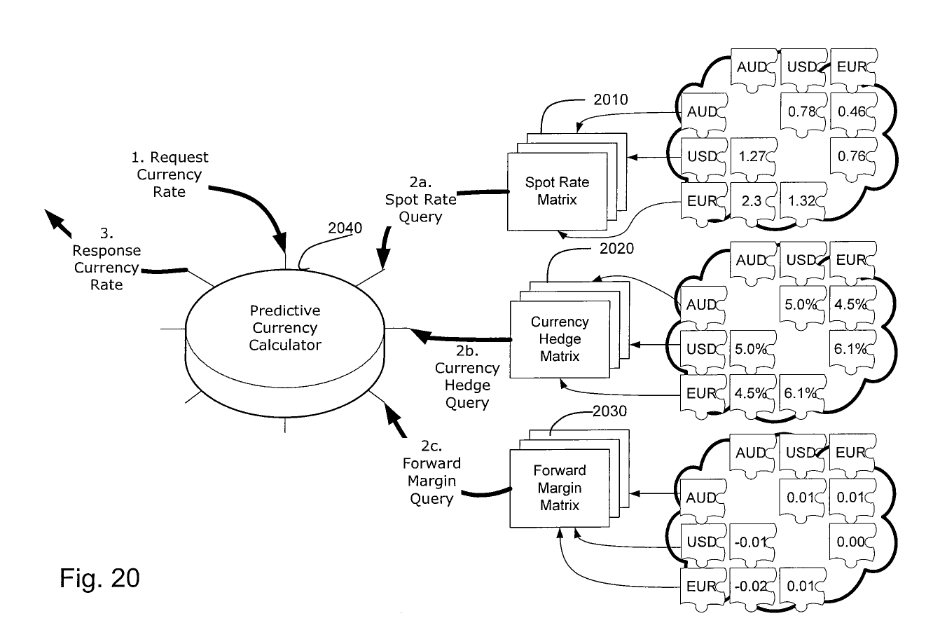

The predictive currency calculator 2040 serves to model the currency market as depicted in FIG. 20. In mathematical terms, a 2D matrix represents a singular rate for a conversion from one currency to another currency, and is represented as the spot rate matrix 2010. Thus, the conversion rate of AUD to USD is different to the rate of USD to AUD. A 3D matrix is established by the use of the forward margin matrix 2030 which establishes the projected currency fluctuations of the foreign exchange market in the relative long term when locking in a conversion rate at time of sale for payment at time of travel. In practice, the difference between the time of sale and the time of travel can be as little as today, to as far out as 12 months and possibly beyond. Projected currency margins are generally well known and established, but as always there is an element of uncertainty associated with it. The predictive currency calculator 2040 is made to closer emulate currency markets by including the currency hedge matrix 2020 which serves to hedge against unexpected fluctuations in the currency in the short term.

The 4D matrix is then established as these rates are entered in not only for today, but for the future, thus establishing a changing 3D matrix over time.

### Productmaster

As mentioned before, one of the core features of the invention is the ability to eliminate duplicate search results where the same product is listed multiple times if it is offered for sale by more than one supplier in the inventory.

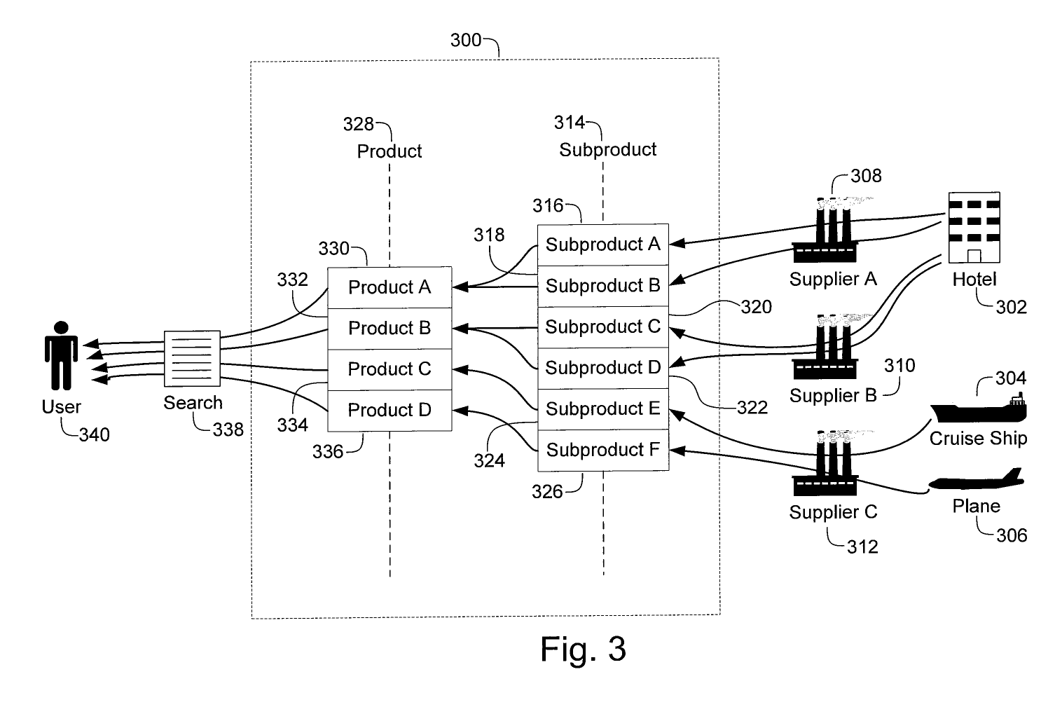

An example of this existing problem is illustrated in FIG. 3, where a traditional booking engine system is depicted. Hotel 302, cruise ship 304 and plane 306 represent the products that are offered for sale, so ideally there should only be three search results displayed to the user at the end. The traditional booking engine typically stores travel product inventory in a “product” relationship within its database 300. This relationship could consist of two classifications: product classification 328 and subproduct classification 314, where one product relates to one or more subproducts.

The product classification 328 contains separate database entries that represent a product offered by a specific supplier. For example, product A 330 represents hotel 302 as offered by supplier A 308, while product B 332 represents the same hotel 302 but offered by supplier B 310. On the other hand, the subproduct classification 314 contains separate database entries that represent different variants of a product offered by a specific supplier. For example, subproduct A 316 and subproduct B 318 represent the rooms in hotel 302 as offered by supplier A 308, subproduct E 324 represents a cabin on cruise ship 304 as offered by supplier B 310 and subproduct D 322 represents a seat on plane 306 as offered by supplier C 312. Each of these variants is priced differently based on one or more criteria. For example, the price of a cabin on a cruise ship can be determined by position, inside or outside, and the deck category or positioning as well as the size and configuration of the cabin. By storing the product inventory into this type of relationship, there will be four product database entries which correspond into four search results 338 being displayed to the user 340 rather than just three. In particular, two of the search results are duplicates due to database entries 330 and 332 both representing hotel 302, but as supplied by two separate suppliers: supplier A 308 and supplier B 310.

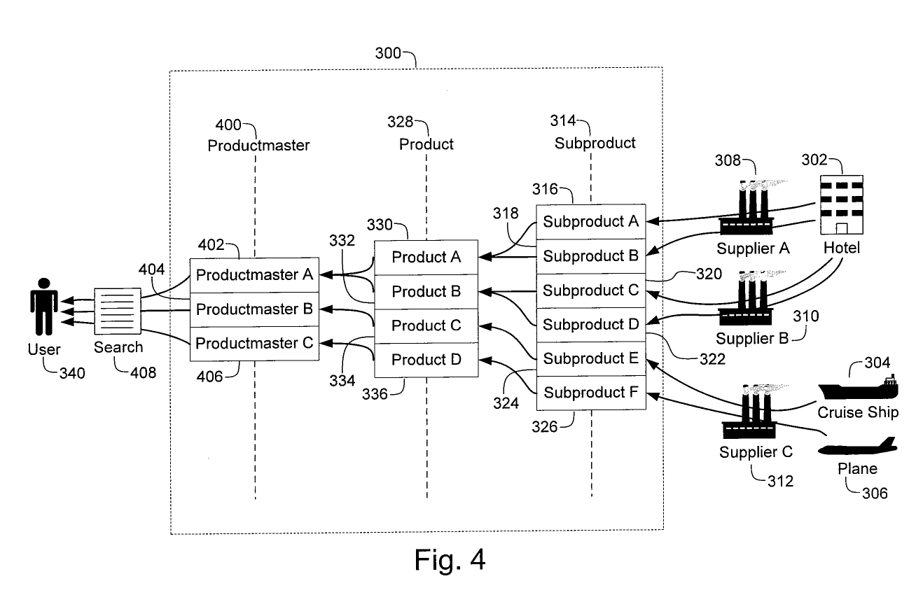

As depicted in FIG. 4 the invention overcomes this duplication problem by storing all travel product inventory in a “Productmaster” relationship within its master database 35. This relationship is an extension of the traditional “product” relationship as detailed previously. In addition to the product classification 328 and subproduct classification 314, there is also a productmaster 400 classification, where one such instance can relate to one or more Products.

The productmaster classification 400 of the master database 35 contains separate database entries where each represent a tangible product being offered for sale, disregarding who it is supplied by. For example, productmaster A 402 is a direct representation of hotel 302 and disregards the fact that it is offered by supplier A 308 and supplier B 310 by linking with product A 330 and product B 332. No information is lost, rather, the two suppliers per product are grouped together. As a consequence of this structure, there will be three productmaster database entries which correspond into three search results 408 being displayed to the user 340.

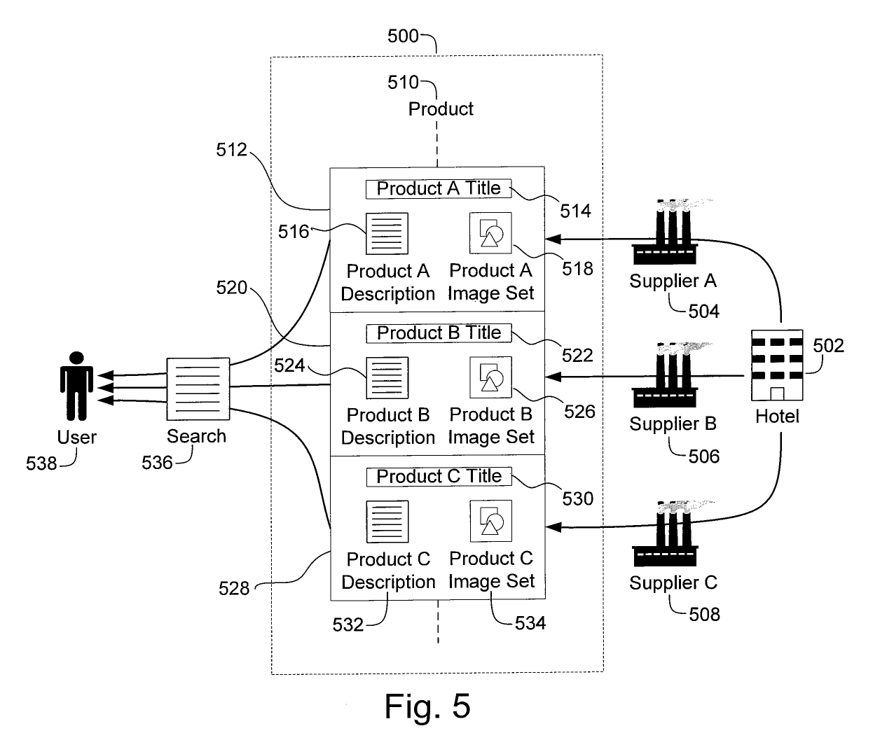

Another problem that the “productmaster” relationship resolves is the inconsistent content and descriptions that are displayed to the user for the same product when the inventory is stored in the traditional “product” relationship structure. FIG. 5 demonstrates an example of this problem, where hotel 502 is sourced by three different suppliers 504, 506 and 508. As a result, there are three corresponding product database entries and each one could possibly contain its own unique set of content and descriptions. For example, product A 512 may have a title 514, description 516 and image set 518 that is totally different to those of product B 520 even though they refer to the same hotel.

This makes the process of selecting a product from the search results much more confusing and less intuitive for the user. For example, User 538 may want to compare all the available choices (Product A 512, B 520 and C 528) for Hotel 502 and select the one with the cheapest price. However their decision making process could be very frustrating since they may take a long time to identify all the corresponding products, depending on the differences in content and description presented, as well as the total number of search results displayed.

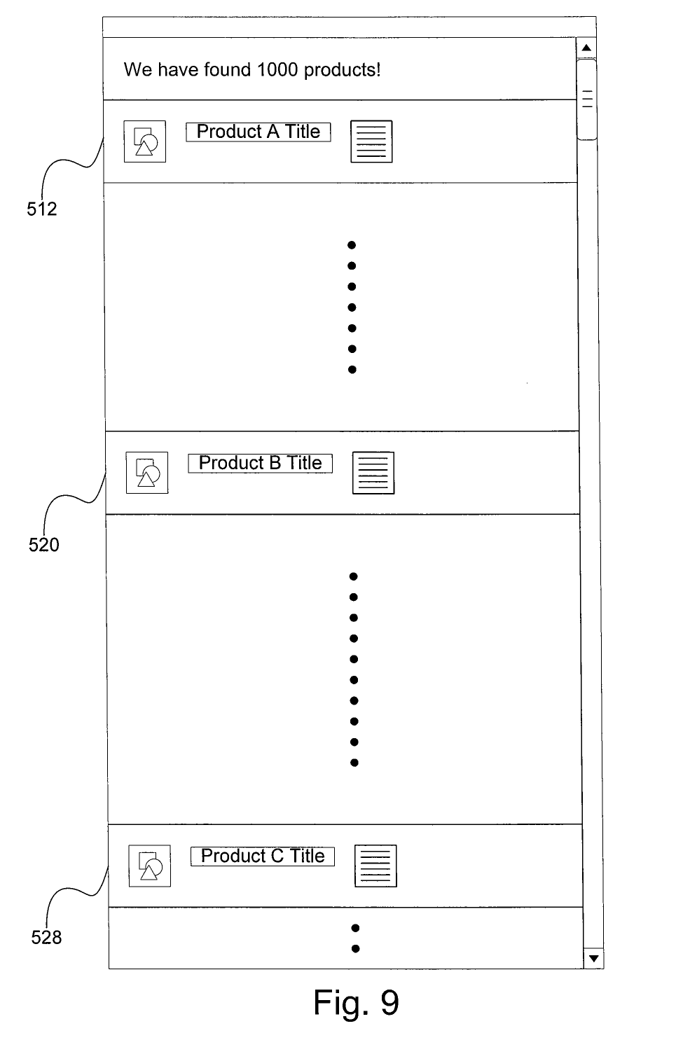

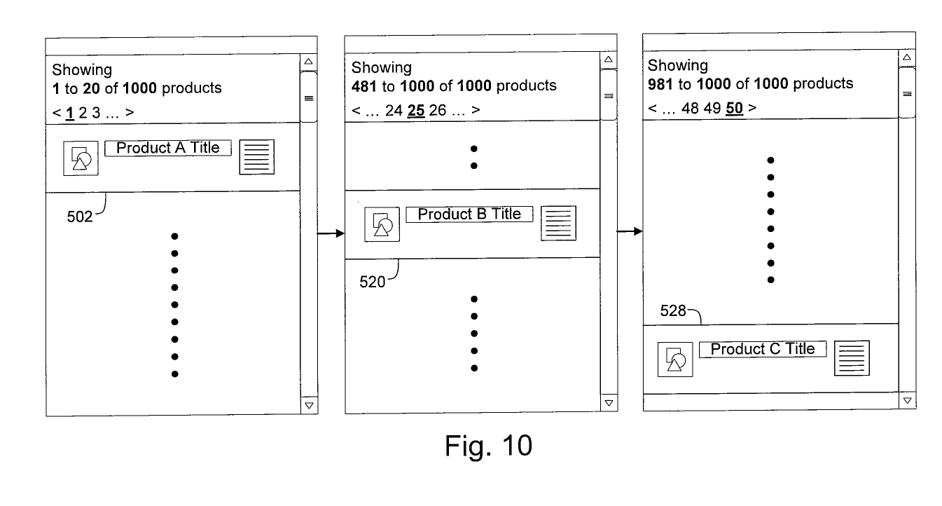

FIG. 9 illustrates a case where there are one thousand search results displayed on a single page to the user (where only 3 of the 1000 results have been depicted). Alternatively, the booking engine may incorporate a pagination engine and separate the results into fifty pages with twenty results per page as shown in FIG. 10. In both cases, product A 512, B 520 and C 528 cannot be always grouped sequentially together through means such as sorting the results by name or other criteria, since they have differing content. Therefore in FIG. 9 the user must carefully browse through the whole page and take note of the prices of each choice as they are identified. Similarly, in FIG. 10 the user must navigate all fifty pages to ensure the best choice is made. Moreover, in the worst case if the user cannot successfully identify all the available choices due to reasons such as the quality of the descriptions, then the selection they make may not be the cheapest and therefore unnecessarily spend more money.

These problems are not prevalent in the “productmaster” relationship structure used by the invention. By having the extra productmaster classification 400, each corresponding product will only have one unique set of content and description that is displayed to the users.

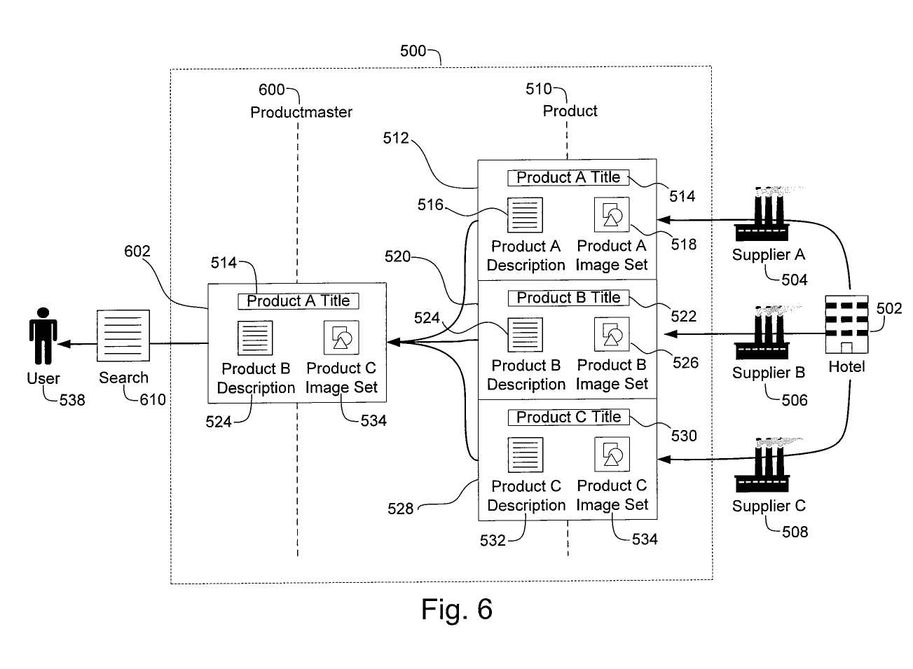

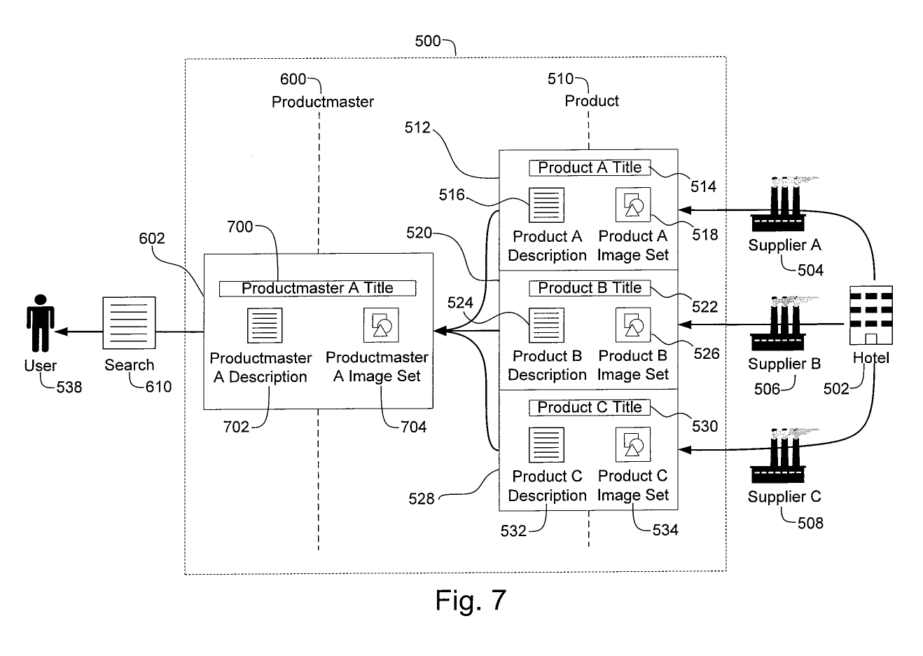

The link between a productmaster and its products provides a flexible structure that allows the wholesaler to derive a single set of content and descriptions in many possible ways. FIG. 6 demonstrates a possibility where Productmaster A 602 could possess the title 514 from product A 512, the description 524 from product B 520 and the image set 534 from product C 528. Alternatively, FIG. 7 demonstrates another possibility where productmaster A 602 has its own title 700, description 702 and image set 704. These components could be totally independent of the products' components or it could be a combination of all of them. For example, the wholesaler could create Productmaster A description 702 by copying some sections from product A description 516, product B description 524 and product C description 532.

One of the benefits of having the extra productmaster level is that it allows the wholesaler to customise the descriptions they want the system to display without affecting those entered by the supplier on the product level. In the traditional booking engine, the wholesaler would have to directly modify the descriptions on the product level if they are not satisfied with its quality, thus interfering with the supplier's data management.

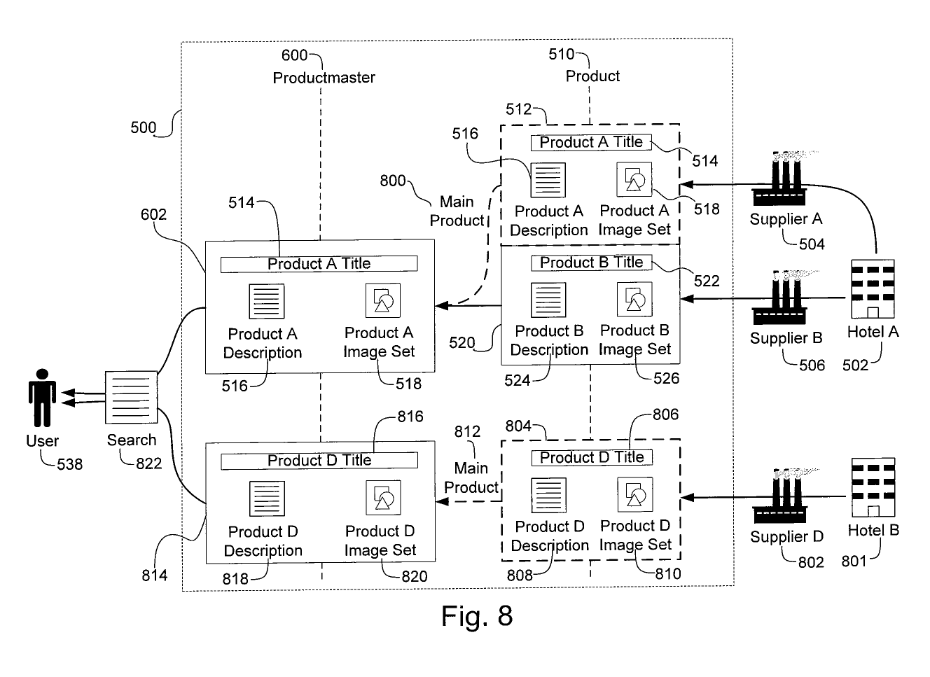

Furthermore, as illustrated in FIG. 8, product A 512 can be setup as the “main product” 800 for productmaster A 602. In this case, productmaster A 602 is a direct replica of product A 512 deriving all its content and descriptions. The main product maintains a one to one relationship with the productmaster level. Whenever product A 512 is updated, the changes are also updated on productmaster A 602. This automation is useful for maintaining the master database if a product is not sourced from multiple suppliers as demonstrated by product D 804, or when the wholesaler wants to streamline the contents by implicitly trusting a particular supplier's content as demonstrated by product A 512.

The process of implementing the stage of grouping product using the productmaster method is described below.

One of the entry points to system 100 includes using three unique identifiers as search criteria in order to find a particular product or subproduct. These three unique identifiers are concatenated to represent the path to find the desired travel inventory. The three unique identifiers are either numerical or alphanumerical which represent the following: (1) productmaster (which actually represents the physical product as supplied by different suppliers), (2) product (which represents products supplied by a specific supplier), and (3) subproduct (which represents a variant of the product as supplied by a specific supplier).

These 3 unique identifiers are joined to create a selectionID, delimited by a full stop “.”. Referring to FIG. 4, Subproduct A 316 belongs to Product A 330 which belongs to Productmaster A 402. Each of the respective entities is uniquely identified in the master database 35, by a unique identifier (UID). The selectionID is thus “PRODUCTMASTER_UID.PRODUCT_UID.SUBPRODUCT_UID”, herein referred to as “X.Y.Z” and informs the information manager 60 of the path taken to find the subproduct of interest. Thus:

“X” refers to the Productmaster UID, which points to the Productmaster.

“Y” refers to the Product UID, which points to the Product.

“Z” refers to the Subproduct UID, which points to the Subproduct.

After the search results have been processed through the application of the rules that determine the pricing of the product, these search results are analysed to identify the X.Y.Z that applies to each entry of the results. The resulting subproducts of interest are then scanned and grouped by the common Productmaster UID. If two or more selectionIDs begin with the same Productmaster UID (note that full stop acts as a delimiter) then the filtering engine combines these results into a singular result, and uses the related Productmaster description to describe that singular result.

The assignation of the selectionID, and in particular, by virtue of the fact that it is comprised of up to three UIDs, presents the operator with the ability to use the UIDs as a further entry point to search for travel product inventory. Thus, if the search engine is provided just “X” as the selectionID (i.e. only the Productmaster UID) as part of its search criteria, then the search engine will not perform an entire database search as it can already deduce that the user is only interested in a particular productmaster. Moreover, if the provided selectionID is in the form of “X.Y”, the search engine can further deduce what the user is interested in, i.e. a particular product as provided by a particular supplier. A selectionID of “X.Y.Z” tells the search engine exactly what subproduct the user is specifically requesting, and returns just that one subproduct (but still using the descriptions from the related productmaster). For example, if the search engine receives a selectionID when a user is requesting for a hotel, this means that:

a selectionID of “X” means the user is interested in staying at a specific hotel.

a selectionID of “X.Y” means that the user is interested in staying a specific hotel provided by a specific supplier.

a selectionID of “X.Y.Z” means that the user is interested in staying at a specific room at a specific hotel provided by a specific supplier.

This particular entry point, using the UIDs as search criteria, is particularly useful for the operators of the system 100, in that they can promote the sale of particular product. For instance, if the operator receives a higher commission from one particular supplier, by linking online advertisements to the search engine, when a consumer who encounters such an advertisement clicks on it, the particular selectionID associated with that advertisement is sent to the search engine of system 100, which then returns to the user the availability, and/or prices of that product.

### Purchase and Processing

When a search is conducted in the search engine, either by the consumer, agency or wholesaler, potential results are returned from the system 100 to the user. If the user wishes to proceed with the selected booking, there are a number of processes required to occur.

Firstly, if the booking is made by the consumer, it is considered a “retail” booking within the system 100. Payment is required upfront for all booking components, and this can be transacted through a live payment gateway that will swipe a given credit card immediately. Authorisation and verification is done automatically, and if the credit card is validated, then the booking proceeds. In the case of wholesalers, they do not need to swipe the card immediately; because they control the booking they can decided whether to charge the full amount upfront, charge a given deposit (the more likely scenario) or not change anything upfront. In the case of an agency, they can be configured to either the retail payment rules or the wholesaler payment rules by the system operator.

When a booking is confirmed, it is saved as such in the travel management system, which effectively accounts for the current booking statuses. It also provides facilities to the user to create documentation immediately from the system from the given descriptions (which can be further customised). This documentation is typically provided in HTML/PDF, though other formats can also exist (such as XML). Documentation types include but are not limited to itineraries, costings, invoices, receipts and vouchers.

Full payment, if not yet received, is generally required at this stage. This allows the finance department to run their credit card reconciliations, bank deposits and bank reconciliations to ensure that what has been entered into the system has indeed occurred.

Once confirmed, invoiced and paid for, the booking sits on a queue until it approaches travel date. No action is required if all operations are in place; once the travel date ticks over, then more options are made available to the wholesaler such as trust release.

Finally, when the booking return date is met, if all the above has been satisfied and the accounts are balanced, the booking is deemed closed.

The travel management system allows the operator to run real time reports on their database. These reports are more often than not created using a custom report library, which allows the user to determine which fields he wants, what criteria he wishes to search on and how to present the ensuing data.

All through the system 100, security components are implemented to allow/disallow people from performing specific actions. These security components are numerous, and can be customised based on the client's needs.

### Implementation

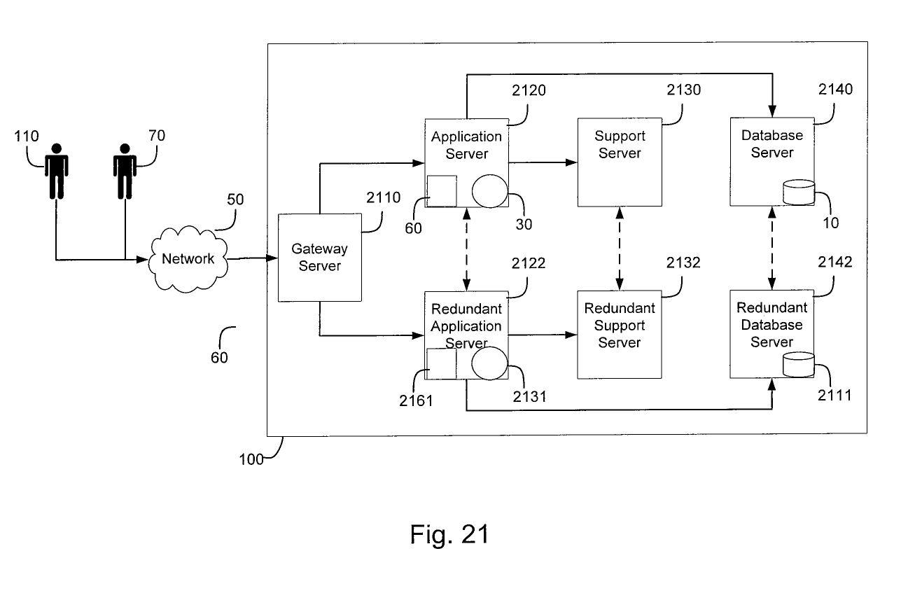

Referring to FIG. 21, the system 100 is implemented over a series of servers that work in tandem to produce the desired result. The network implementation, as depicted in FIG. 21, illustrates how the servers can interact with each other to maximise efficiency and capacity. The system 100 is logically made up of the information manager 60 and a datastore 10, and these can physically exist on two different servers' application server 2120 and database server 2140 respectively. It also incorporates a gateway server 2110, whose purpose is to direct network traffic from user 70 and user 110 via network 50 into application server 2120. While a trivial task, the gateway server 2110 can implement network level logic that could potentially detect erroneous or malicious data, and filter this information before it gets to application server 2120. This leaves application server 2120 to handle only those requests that are valid and trusted. Gateway server 2110 can also implement a load balancer than can ensure that users get a fair network response, and not be adversely affected by other resource hungry users.

When a request hits the application server 2120, it is very likely to interact with database server 2140 and possibly support server 2130. The interaction with the database server 2140 is to retrieve information from the datastore 10. Because the datastore 10 is an integral part of the system, and is heavily relied upon, the existence of a separate physical database server can alleviate the resource load from the application server. However, it is also physically possible to have application server 2120 and database server 2140 on the same server, although this does impact on performance of the system 100.

Where information from the datastore 10 is retrieved, it is more often than not stored in the intuitive cache 30 for future reference. Thus, when the same data is requested by the information manager 60, it will retrieve it from the intuitive cache 30 instead of interrogating the datastore 10. The intuitive cache 30 builds up over time in memory and the system 100 will theoretically run faster over time.

The support server 2130 is used for specific purposes by the application server 2120 that are either time consuming, resource intensive or requiring a specific server configuration that is not available on the application server 2120. By serialising these services to another physical server, the application server 2120 is not over burdened by mundane tasks, and responds in a timely manner to the users 70 and 110.

The servers all reside on the same network and communicate to each other via TCP/IP. Because they are local to each other, the TCP/IP connections are very fast and are not hampered by any network bandwidth restrictions.

All servers can be maintained locally (ie. physically accessible at the server) or remotely. When accessed locally, this is achieved through standard physical means via a keyboard and mouse. When accessed physically at the server, information is displayed to an LCD/CRT screen. When accessed remotely for maintenance or otherwise, access is achieved through SSH (secure shell) through the network 50, authenticated by a certificate. Other standard means of access are generally not allowed (such as telnet, FTP) as these methods are generally accepted as insecure means of access.

All servers are loaded with multiple hard drives configured in a RAID5 configuration with a single hot spare (backup hard drive). This hard drive configuration serves to increase data integrity, fault tolerance and throughput. The hard drives employed are ultra-fast SCSI hard drives, which have faster seek times and perform faster than standard hard drives.

All servers also have sister production servers that serve as redundancy. Redundant application server 2122, redundant support server 2132 and redundant database server 2142 are the sister production servers of the application server 2120, support server 2130 and database server 2140 respectively. These redundant servers are mirrored more or less in totality from the main production server at regular intervals during the day.

The datastore 10 also has a real time redundancy operation, which theoretically enables the redundant datastore 2111 to be an exact replica of datastore 10 at any given time. This is imperative as the data stored in the datastore 10 the most critical aspect of the system 100.

The datastore 10 is also dumped out and zipped up, then transferred offsite daily to another location. This is a fairly intensive process, both in resource and hard drive space, and is normally scheduled to run outside of normal business hours to have a minimal effect on users.

Disaster recovery methods are an important aspect of the implementation. There are X points of identified failure, and the disaster recovery methods associated with each. Each point has explained what has failed, what the recovery plan is, anticipated time for recovery and anticipated loss of data. These points are explained below in order of trivial faults to critical faults.
(a) In the event of a single hard drive failure in the application server 2120, support server 2130 or database server 2140, the RAID hard drive configuration can tolerate this failure and continue normal operations. The hot spare hard drive comes live and data is rebuilt real time. There is no loss of data, and there is no downtime.
(b) In the event of 2 or more hard drives failing, or a complete server failure in the application server 2120, support server 2130 or database server 2140, then the respective redundant server will come live. This normally takes a few moments for the network configuration to reroute itself. If needed, the most recent data can be restored from the RAID drives of the production server if need be. Normally this is not required as the datastore 10 is mirrored real time to redundant datastore 2111. There is normally minimal loss of data, and there is a short downtime.
(c) In the event of the production server and the redundant server failing, then the off site backup is restored to a failsafe server and put into test phase. Because the data is effectively obsolete, data integrity checks must be made against the failed production server or the failed redundant server. There is normally some degree of lost data, and there is a long downtime, depending on the nature of the disaster.

With the hardware in place, there are several steps in setting up a new operator to use the system 100 before they are operational. Firstly, a new datastore 10 is setup on the database server 2140 and the scheduled redundancy jobs are set up to ensure a backup on redundant database server 2142. Then the information manager 60 and associated components (including the intuitive cache 30) are installed from the software repository and stored onto the application server 2120. Each operator uses their own information manager 60 and their own related components to ensure that the system 100 for this operator is kept separate from other operator systems maintained on the same set of hardware. Thus, it is possible to provide a service whereby a multiple operator's systems 100 can coexist on the one set of hardware and individual operator systems can be shut down and restarted without affecting other operators. Moreover, each system 100 can be running a different version to the other operators' systems.

Once the software and hardware is setup, the next step in the implementation process is to enter data into the master database 35. In the case where the operator has maintained a traditional or prior art database of it's own inventory, the process of entering the data into the master database 35 could be as simple as exporting the data from the old database into the new database, and during which each new database entry in master database 35 is automatically assigned a productmaster UID, product UID, and a subproduct UID. However, in some cases, this data may also be entered into the master database 35 manually by the operator, or where access is granted, manually by the supplier. The data set contained within the master database, may as a result of manual entry of data, or the structure or the quality of the original data, may still contain duplicate product entries referring to the same actual travel product inventory. In such cases, the operator will need to analyse the data set and resolve the duplication by assigning a unique productmaster UID to each entry that refers to the same actual travel product inventory.

Therefore, each database entry in the master database 35 will have a unique selectionID, which as described previously, is a concatenation of the three UIDs (listed above) to determine “X.Y.Z”.

The next step in implementing the system 100 involves establishing if there are any external databases 20 to connect to. This will determine if any ghost databases 25 are required to be built within datastore 10. If so, the operator must negotiate commercial agreements with the operator of external database 20. Depending on the external database 20 to be connected to, the operator of the system 100 needs to tailor an XML supplier API 119 to the API utilised by the external database 20. For example, if the operator wanted to connect system 100 to the Sabre database it would need to tailor an XML Supplier API 119 to match the Sabre databases API. Thus, the manner in which ghost databases 25 are mapped or mirror external databases 20, will depend on the external database's 20 API. For example, some APIs for certain databases only allow daily updates, whereas others allow real time searching.

Setting up the connection to external database 20 includes but is not limited to the following steps:
Establish an XML connection to from the XML Supplier API 119 using the communication module 40. This XML connection is custom built per XML Supplier as each XML Supplier is connected through different means. For example, one XML Supplier may offer connectivity through a simple HTTP protocol using GET/POST methods, while another XML Supplier may offer connectivity through SOAP requests. Other XML Suppliers require the communications module 40 to install software locally, and use this software to connect.
Download as much static information from the external database 20 through network 50 into the associated ghost database 25. Static information is data that rarely changes, and includes names of products, and their associated descriptions and images.
We then process the ghost database 25 to effectively create “cloned” products that are mapped across to the master database 35 which ordinarily also contains travel product inventory that has been entered by the operator of the system 100. During this process there is a reference created between the master database 35 and the ghost database 25 which is used to link databases entries. Often, a unique productmaster, product and subproduct is created, thus creating UIDs which represent a selectionID X.Y.Z.
It is at this point, the operator of the system 100 can analyse the database entries in the master database 35 for entries that represent the same physical product being provided by multiple suppliers. This process only needs to be done once, and is a manual process. In particular, distinct productmaster UIDs are resolved into the same productmaster UID, so that when a search is conducted and multiple results are provided, information manager 60 is able to group the search results by the productmaster UID and thereby provide a set of search results where each result represents one actual travel product. This overcomes the problem of multiple instances of the same actual travel product being returned in the one set of search results. For example, if during the importation of the database entries from the external database 20 to the ghost database 25 and into the cloned portion of master database 35, an entry for “The Sheraton on the Park, Sydney” is imported, and there was already an existing entry in the master database 35 for “Park Sheraton, Sydney”, then the operator of system 100 would need to consolidate the two entries into a single productmaster UID.
Create the dynamic information communications handler within the XML Supplier API 119. This serves to retrieve the dynamic information that is required to complete a search, and includes, but is not limited to, information such as prices, availability, summary descriptions, number of rooms available, etc. The retrieval of dynamic information can be synchronous or asynchronous depending on the capabilities of the external database 20. This information is highly dynamic and can change on a minute by minute basis. The communications handler is usually used when a search query is initiated.

Various modifications may be made in the details of design and construction without departing from the scope and ambit of the invention.

1. A system for providing travel product, wherein the travel product inventory is contained in at least one external database, the system comprising:
a datastore containing at least
one ghost database comprising a mirror of the at least one external database containing travel product inventory wherein the ghost database is periodically updated, and
a master database containing at least a clone of the ghost database, wherein each entry of the master database has assigned to it a unique identifier;
a communications module, which is adapted to communicate with the at least one external database and to receive search criteria from a user connected to the system via a network;
an information manager adapted to receive the search criteria and query the at least one external database containing travel product inventory; and
wherein the information manager queries the at least one external database by first querying the master database to identify relevant travel product inventory, and if identified in the master database, uses this information to look up the corresponding entry in the ghost database, and;
in the case where the ghost database is updated frequently such that it represents an accurate representation of the availability and prices of the travel product inventory contained therein, the information manager uses the information contained in the ghost database, or
in the case where the ghost database is updated infrequently, the information manager uses the information obtained from the ghost database to access the at least one external database via the communications module, so as to obtain current pricing and/or availability of the relevant travel product identified in the earlier searches of the master database and at least one ghost database, and
wherein the search results, including the availability and/or the price of the travel product inventory revealed by the searches are returned to the user by the information manager via communications module and network.

2. The system of claim 1, wherein the system further comprises:
a cache for storing past search results; and
wherein the information manager searches the master database and at least one external database utilising:
an XML gateway of the information manager, which is adapted to direct the search criteria submitted by the user connected to the system, to both:
an XML master database API further adapted to query the cache to identify any previously provided search results which meet the search criteria of the user and further adapted to query the master database for travel product inventory that meets the search criteria of the user; and
an XML supplier API further adapted to first query the master database for travel product inventory that meets the search criteria of the user, and if identified, to use this information to look up the corresponding entry in the ghost database and if relevant product inventory is identified, query the cache to identify whether the relevant product information is stored in the cache, and if not stored or if the content of the ghost database is not accurate, queries the external database via communications module to determine actual availability and/or price.

3. The system of claim 2, wherein there is a plurality of external databases each of which is in association with a XML supplier API.

4. The system of claim 3, wherein the search criteria includes destination criteria such that when the user starts to type the destination the system provides automatic suggestions from a list maintained in a destinational cache.

5. The system of claim 4, wherein each destination comprises at least two hierarchical destination levels, including:
Country, and
City.

6. A system for pricing travel product, the system comprising:
a datastore for containing at least one master database having at least a set of rules wherein the rules are applicable to the pricing of travel products;
an information manager for:
receiving search criteria from a user connected to a system,
identifying the user,
querying at least the master database in the datastore,
applying the rules applicable to any travel product inventory identified so as to obtain a display price,
sending the search results to the user connected to the system, including the display price of the travel product identified in the search results,
receiving orders for the purchase or reservation of the travel product; and
a communications module for communicating with at least the user connected to the system via a network.

7. The system of claim 6, further comprising:
a cache for storing past search results which are accessed by the information manager in order to speed up database queries of at least the master database, and
wherein the rules provide for at least:
differential prices to be paid based on the user,
differential prices to be paid based on sales channels, and
differential prices to be paid based on the product.

8. The system of claim 7, wherein the information manager is further adapted to query at least one external database in addition to the master database of the system, and wherein
the datastore further comprises:
at least one ghost database for the or each external database,
the master database which further comprises a clone of the or each ghost database,
the information manager further comprising:
an XML gateway, which is adapted to direct the search criteria submitted by the user connected to the system, to both:
an XML master database API further adapted to query the cache to identify any previously provided search results which meet the search criteria of the user and further adapted to query the master database for travel product inventory that meets the search criteria of the user;
an XML supplier API further adapted to first query the master database for travel product inventory that meets the search criteria of the user, and if identified, to use this information to look up the corresponding entry in the ghost database and if relevant product inventory is identified, query the cache to identify whether the relevant product information is stored in the cache, and if not stored or if the content of the ghost database is not accurate, queries the external database via communications module to determine actual availability and/or price; and
wherein the results of the queries of both XML master database API and XML supplier API then have the rules applied to them in order to obtain the display price and are thereafter provided to the user via the communications module and network.

9. The system of claim 7, wherein there is an assigned hierarchy to the rules so that certain rules take precedence over others, and wherein the rules can be applied either:
cumulatively, or
absolutely, or
a combination of absolutely and cumulatively; and
wherein the rules define at least the markup, discount, and commission payable in respect of a particular travel product inventory.

10. The system of claim 7 wherein before the information manager applies the rules applicable to the travel product inventory identified, the information manager first applies a currency conversion and wherein the rate of conversion is derived from a combination of the applicable spot rate, currency hedge and forward margin.

11. A system for eliminating duplication in the results of the search conducted for travel product inventory in a system which contains multiple instances of actual travel product inventory supplied by different suppliers, the system comprising:
a datastore for storing a master database containing travel product inventory wherein each entry in the master database has a unique selectionID including unique productmaster UID, product UID, and subproduct UID;
an information manager adapted to:
receive search criteria from a user connected to the system,
query at least the master database of the datastore for relevant travel product inventory, and
analyse the returned search results for instances where the entries of the master database returned have identical productmaster UIDs, and groups these entries with identical productmaster UIDs together, and provides the results to the user grouped by productmaster; and
a communications module for communicating with at least the user over a network.

12. The system of claim 1, wherein the unique identifier associated with entries in the master database includes at least a unique productmaster UID, product UID, and subproduct UID, and wherein the search results obtained by the information manager are analysed by it for duplicate entries that have the same productmaster UID, and wherein the information manager then groups these duplicate entries together before providing the grouped search results to the user connected to the system.

13. The system of claim 2 wherein the unique identifier associated with entries in the master database includes at least a unique productmaster UID, product UID, and subproduct UID, and wherein search results returned by the XML master database API and XML supplier API of the information manager are analysed by the information manager for duplicate entries that have the same productmaster UID.

14. A system for providing and pricing travel product inventory contained in at least one external database, comprising:
a datastore containing:
at least one ghost database where the or each ghost database represents a mirror of the at least one ghost database having travel product inventory contained therein;
a master database containing a clone of the at least one ghost database wherein each entry of the master database has assigned to it a unique selection ID comprising unique productmaster UID, product UID, and subproduct UID;
an information manager adapted to:
receive search criteria from a user connected to the system,
identifying the user,
querying the master database from the datastore,
querying the at least one external database containing travel product inventory,
applying the pricing rules applicable to any travel product inventory identified through querying the databases,
analysing the search results for instances of entries in the search results that contain the same unique productmaster UIDs,
grouping the entries with the same unique productmaster UIDs,
returning the search results that have been priced and grouped according to productmaster UID to the user connected to the system, via
a communications module which is adapted to communicate with the at least one external database and the user via a network.

15. The system of claim 14, wherein the system further comprises:
a cache for storing past search results; and
wherein the information manager further comprises:
an XML gateway, which is adapted to direct the search criteria submitted by the user connected to the system, to both:
an XML master database API further adapted to query the cache to identify any previously provided search results which meet the search criteria of the user and further adapted to query the master database for travel product inventory that meets the search criteria of the user;
an XML supplier API further adapted to first query the master database for travel product inventory that meets the search criteria of the user, and if identified, to use this information to look up the corresponding entry in the ghost database and if relevant product inventory is identified, query the cache to identify whether the relevant product information is stored in the cache, and if not stored or if the content of the ghost database is not accurate, queries the external database via communications module to determine actual availability and/or price; and
wherein the results of the queries of both XML master database API and XML supplier API are returned to the user connected to the system via communications module and network.

16. The system of claim 15, wherein the rules provide for:
differential prices to be paid based on the user;
differential prices to be paid based on sales channels; and
differential prices to be paid based on the product.

17. The system of claim 16, wherein the search criteria includes destination criteria such that when the user starts to type the destination the system provides automatic suggestions from a list maintained in the destinational cache and wherein each destination comprises at least two hierarchical destination levels, including:
Country, and
City.

18. The system of claim 17, wherein before the information manager applies the rules applicable to the travel product inventory identified, first applies a currency conversion and wherein the rate of conversion is derived from a combination of the applicable spot rate, currency hedge and forward margin.

19. A method for providing travel product through an integrated internet mediated travel booking system for use by travel agents, retail consumers, wholesalers and aggregators comprising the following steps:
defining rules applicable to the sale of travel products where rules provide for, at least,
differential prices to be paid based on the user,
differential prices to be paid based on sales channels, and
differential prices to be paid based on the product; and
connecting to at least one database containing product information;
associating rules with the product information;
obtaining from a user a set of search criteria;
searching the at least one database for relevant product information, by applying the search criteria to its contents;
obtaining a first set of raw search results of relevant product information;
applying the set of rules which are applicable to:
the user,
the source database,
the product;
in order to derive a final sales price for the particular user;
analysing the search results for multiple instances of actual travel product inventory where a supplier has provided multiple subproducts and in those cases, grouping them together under the one product for each supplier;
grouping the grouped search results further, where the results relating to the same actual product offered by multiple suppliers are grouped and returned as one search result;
providing the grouped search results to the user with the calculated prices, grouped by actual product, via a communications module;
allowing the user to select the product and choose the supplier if multiple suppliers are available for an actual product, and thereafter;
complete the purchase and/or make a reservation.

20. The method of claim 19, wherein searching the at least one database comprises the following steps:
an XML gateway receiving from the communications module the search criteria provided by the user of the system;
the XML gateway performing a lookup of data contained in the datastore indicating where product of the desired service type requested might reside;
the XML gateway sending the search criteria to XML API's for accessing content contained in the master database, and any other external database which potentially contains product information of interest;
the master database XML API, an XML API having been provided the search criteria by the XML gateway, first querying the cache to determine whether there are any recent search results that meet the criteria of the user, and if no cached search results are identified, querying the master database for relevant product information, and at the same time, any supplier XML API sent the search criteria by the XML gateway then queries the master database for relevant product information specific to the external database and thereafter queries the ghost database contained within the datastore of the system, and in the event that relevant product information is identified, then queries the cache for any recently cached search result that contains the relevant product information and in the event that there is no relevant cached search results, will query the external database for up to date information including availability and/or price;
the master database XML API and any supplier XML API that has conducted a search then returns the search results for application of the rules so as to obtain a final price for any product information identified, based on the identity or type of user, and the source or channel of the product to which the product information relates;
providing the user with the search results as modified by the application of the rules via a communication module.
